(19) United States
(12) Patent Application Publication
(10) Pub. No.: US 2011/0055062 A1
(43) Pub. Date: Mar. 3, 2011

(54) Activity Scheduling and Clearinghouse System

(75) Inventors: Dawn Marie Juntilla, Inver Grove Heights, MN (US); Dale Robert Szymborski, Eden Prairie, MN (US)

(73) Assignee: RPS HOLDINGS, INC., Eagan, MN (US)

(21) Appl. No.: 12/822,798

(22) Filed: Jun. 24, 2010

Related U.S. Application Data
(60) Provisional application No. 61/222,783, filed on Jul. 2, 2009.

(51) Int. Cl. G06Q 10/00; G06F 17/30; G06Q 30/00

(52) U.S. Cl. 705/34; 707/802; 707/769; 707/E17.005; 707/E17.014

(57) ABSTRACT

A method and system for managing activity registrations using an activity clearinghouse system includes receiving requests from a plurality of activity providers to create activity records in the activity database, where each activity record including a plurality of activity parameters. The method also includes receiving system a request from a user to view one or more of the activity records, the request including at least one activity parameter selected by the user. The method includes, in response to the request, providing to the user the one or more activity records including the at least one activity parameter selected by the user. The method also includes receiving a request from the user to register an individual for a selected activity associated with an activity record, and updating the activity record to reflect registration of the individual for the selected activity.

### RELATED APPLICATION

This application claims the benefit of U.S. Patent Application Ser. No. 61/222,783 filed on Jul. 2, 2009, the entirety of which is hereby incorporated by reference.

### BACKGROUND

Municipalities and private organizations often organize activities for the benefit of the general public. For example, municipalities or private organizations may organize sports leagues, classes, camps, or other activities. These activities can be designated as having an intended audience defined by an age group (e.g., adults or children of a particular age range), skill level (e.g., novice, intermediate, advanced), residency (e.g., resident or non-resident of a host municipality), gender (male, female, or mixed-league) or any of a number of other factors. Each activity typically can have a registration fee or other expense associated with that activity, and may have informative literature associated with the activity. Additionally, these activities are offered on predetermined schedules, recurring over a defined period of time, and each typically has its own set of rules and regulations.

Activity provider organizations (e.g. municipalities or other organizations) expend effort to publicize their planned activities, to ensure that possibly interested individuals are aware of those activities and can register for the activities. Concurrently, individuals wishing to participate in an activity must research which activities are available and convenient, and then locate those activities appropriate for their participation. This often involves contacting a number of different organizations responsible for organizing these activities, collecting information about activities of interest, and then separately registering for selected activities that fit the skills, interests, and demographics of that individual. The participating individuals must then personally track and coordinate their activity schedules and retain information about the activity rules and regulations, as well as the timing, duration, frequency of the activity.

An individual (e.g. a parent) wishing to register a child in activities faces additional complexity, because the activities selected for the child must fit within the child's schedule, and must be sufficiently convenient for the individual. Furthermore, individuals wishing to register more than one child in activities must also contact each of these disparate sources to register their children for activities, but they typically also have to coordinate transportation for their children and keep track of multiple sets of activity information.

### SUMMARY

In a first aspect, an activity clearinghouse system includes a memory and a programmable circuit. The memory is configured to store an activity database containing a plurality of activity records. The programmable circuit is operatively connected to the memory and configured to execute programmable instructions. When executed, the programmable instructions cause the activity clearinghouse system to receive requests from a plurality of activity providers to create activity records in the activity database, each activity record including a plurality of activity parameters. The programmable instructions also cause the activity clearinghouse system to receive a request from a user to view one or more of the activity records, the request including at least one activity parameter selected by the user. The programmable instructions also cause the activity clearinghouse system to, in response to the request, provide to the user the one or more activity records including the at least one activity parameter selected by the user. The programmable instructions also cause the activity clearinghouse system to receive a request from the user to register an individual for a selected activity associated with an activity record, and update the activity record to reflect registration of the individual for the selected activity.

In a second aspect, a method of managing activity registrations using an activity clearinghouse system includes receiving at the activity clearinghouse system requests from a plurality of activity providers to create activity records in the activity database, each activity record including a plurality of activity parameters. The method also includes receiving at the activity clearinghouse system a request from a user to view one or more of the activity records, the request including at least one activity parameter selected by the user. The method further includes, in response to the request, providing to the user the one or more activity records including the at least one activity parameter selected by the user. The method also includes receiving at the activity clearinghouse system a request from the user to register an individual for a selected activity associated with an activity record, and updating the activity record to reflect selection and registration of the individual for the selected activity.

### DESCRIPTION OF THE DRAWINGS

FIG. 1 is a schematic depiction of an activity registration network;

FIG. 2 is a schematic depiction of functionality and data records hosted by an activity database, according to a possible embodiment of the present disclosure;

FIG. 3 is a schematic depiction of functional modules used for provider administration in an activity clearinghouse system, according to a possible embodiment of the present disclosure;

FIG. 4 is a schematic depiction of functional modules used for user administration in an activity clearinghouse system, according to a possible embodiment of the present disclosure;

FIG. 5 is a schematic depiction of functional modules used for event administration in an activity clearinghouse system, according to a possible embodiment of the present disclosure;

FIG. 6 is a block diagram illustrating example physical components of an electronic computing device;

FIG. 7 illustrates an example user interface displaying a provider account summary for a provider registered with an activity clearinghouse system, according to a possible embodiment of the present disclosure;

FIG. 8 illustrates an example user interface displaying activity provider membership selection options, according to a possible embodiment of the present disclosure;

FIG. 9 illustrates an example user interface displaying promotion settings useable by an activity provider, according to a possible embodiment of the present disclosure;

FIG. 10 illustrates an example user interface displaying activity provider policy notes, according to a possible embodiment of the present disclosure;

FIG. 11 illustrates an example user interface displaying activity provider billing options, according to a possible embodiment of the present disclosure;

FIG. 12 illustrates an example user interface displaying activity provider profile settings, according to a possible embodiment of the present disclosure;

FIG. 13 illustrates an example user interface displaying activity provider password settings, according to a possible embodiment of the present disclosure;

FIG. 14 illustrates an example user interface displaying additional activity provider profile settings, according to a possible embodiment of the present disclosure;

FIG. 15 illustrates an example user interface displaying activity provider location settings, according to a possible embodiment of the present disclosure;

FIG. 16 illustrates an example user interface for adding or editing locations displayed in FIG. 15;

FIG. 17 illustrates an example user interface displaying customer profiles to an activity provider, according to a possible embodiment of the present disclosure;

FIG. 18 illustrates an example user interface displaying a customer search form useable by an activity provider, according to a possible embodiment of the present disclosure;

FIG. 19 illustrates an example user interface displaying activity listings managed by an activity provider, according to a possible embodiment of the present disclosure;

FIG. 20 illustrates an example user interface displaying a new activity listing form, according to a possible embodiment of the present disclosure;

FIG. 21 illustrates an example user interface displaying an activity listing import form useable by an activity provider, according to a possible embodiment of the present disclosure;

FIG. 22 illustrates an example user interface listing activity providers registered with an activity clearinghouse system, according to a possible embodiment of the present disclosure;

FIG. 23 illustrates an example user interface listing additional activity providers, in particular camp providers, registered with an activity clearinghouse system, according to a possible embodiment of the present disclosure;

FIG. 24 illustrates an example user interface allowing user search for activities available through an activity clearinghouse system, according to a possible embodiment of the present disclosure;

FIG. 25 illustrates an example user interface allowing user search for activities, in particular camp activities, available through an activity clearinghouse system, according to a possible embodiment of the present disclosure;

FIG. 26 illustrates an example user interface allowing editing of user contact preferences;

FIG. 27 illustrates an example user interface allowing editing of user billing preferences;

FIG. 28 illustrates an example user interface displaying individuals associated with a user account;

FIG. 29 illustrates an example user interface for editing a profile of an individual associated with a user account;

FIG. 30 illustrates an example user interface for adding a profile of an individual to a user account;

FIG. 31 illustrates an example user interface for user selection of an activity for an individual associated with that user;

FIG. 32 illustrates an example user interface upon selection of an activity as illustrated in FIG. 31;

FIG. 33 illustrates an example user interface displaying a shopping cart of user activities selected using the user interfaces of FIGS. 31-32;

FIG. 34 illustrates an example user interface displaying a calendar of activities for a plurality of individuals associated with a user;

FIG. 35 illustrates an example user interface displaying announcements by providers for activities in which a user has registered one or more individuals;

FIG. 36 illustrates an example user interface facilitating possible carpooling to activities;

FIG. 37 illustrates an example user interface allowing display and sharing of photographs associated with activities associated with the user;

FIG. 38 is a flowchart of methods and systems for facilitating creation and management of activities using an activity clearinghouse system; and

FIG. 39 is a flowchart of methods and systems for facilitating browsing and registration in activities and management of activity schedules using an activity clearinghouse system.

### DETAILED DESCRIPTION

Various embodiments of the present disclosure will be described in detail with reference to the drawings, wherein like reference numerals represent like parts and assemblies throughout the several views. Reference to various embodiments does not limit the scope of the disclosure, which is limited only by the scope of the claims attached hereto. Additionally, any examples set forth in this specification are not intended to be limiting and merely set forth some of the many possible embodiments.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general the present disclosure relates to an activity clearinghouse system, such as can be used to allow activity providers to publish activities for access by users, and by users to browse and register for activities on behalf of one or more individuals. The activity clearinghouse system of the present disclosure allows centralized management of information, which can reduce the need for activity providers to publicize activities and manually manage registration for such activities, while making it easier for users to find, register for, and manage activities of interest.

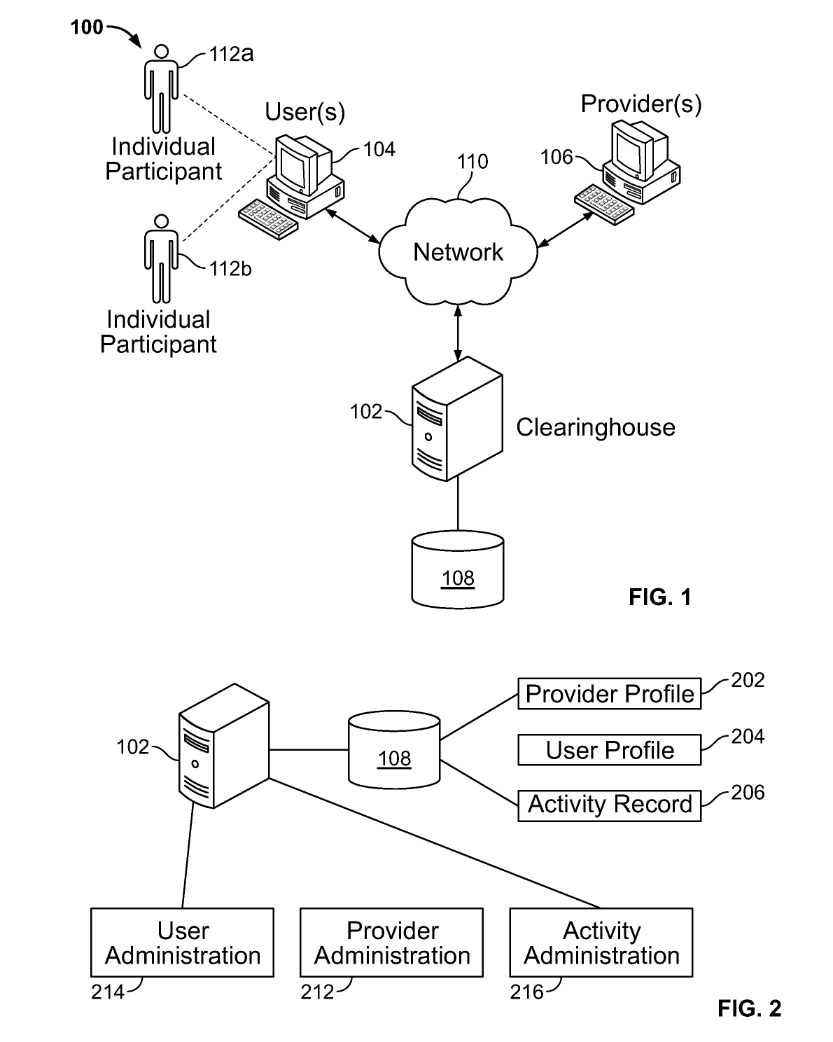

Referring now to FIG. 1, a schematic depiction of an activity registration network 100 is illustrated. The activity registration network 100 illustrates access to an activity clearinghouse system 102 by a number of users 104 and providers 106.

The activity clearinghouse system 102 is capable of storing and managing information relating to activities hosted by the providers 106. The activity clearinghouse system 102 can correspond to one or more computing systems, and is associated with and in communicative connection with an activity database 108.

The activity database 108 stores records relating to activities including activity records, user profiles, provider profiles, and individual profiles. Additional details regarding the various records stored in the activity database 108 are provided in conjunction with FIGS. 2-5.

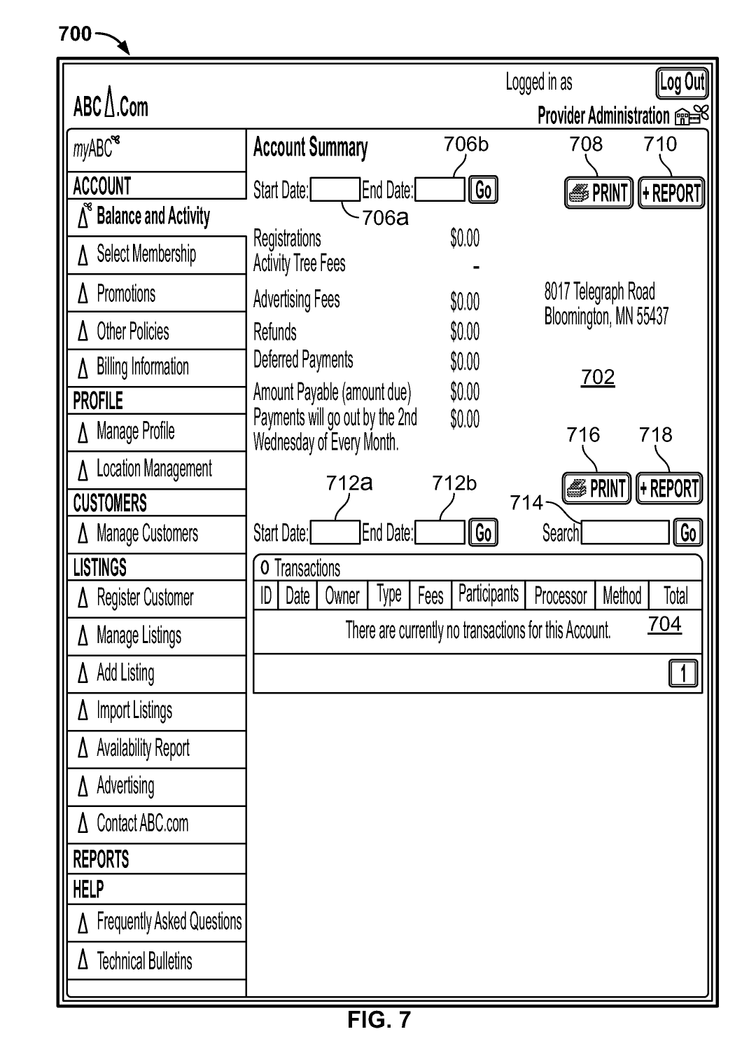

Additionally, the activity clearinghouse system 102 is capable of generating and presenting to the users 104 and providers 106 a number of user interfaces for access and management of these various types of records. Certain examples of user interfaces are described in detail below in FIGS. 7-37.

In the embodiment shown, the activity clearinghouse system 102 is connected to the users 104 and providers 106 by way of a network 110. The network 108 can be any of a number of types of communicative connections, such as wired, wireless, or other connections. In one embodiment, the network 110 corresponds to the Internet.

In the examples shown, the users 104 and the providers 106 use one or more computing devices (see, e.g., computing device 600 described below) to communicate with the system 102, which itself includes one or more computing devices. In such examples, the users 104 and providers 106 can be considered to be clients, and the system 102 can be considered to be a server.

The users 104 are individuals capable of accessing the activity clearinghouse system 102, and authorized to register themselves or others into one or more activities. In certain examples, the users 104 can correspond to individuals registering themselves for activities; in other examples, the users 104 can be parents or guardians of minor children and can register those children for activities on their behalf. The users 104 therefore can use the activity clearinghouse system 102 to register more than one individual (illustrated as individuals 112a-b) in the same or different activities, and have those individuals associated with the user's account (e.g., for payment, scheduling, calendaring, and other features of the activity clearinghouse system as described herein).

The providers 106 are typically municipalities or other organizations seeking to host activities for which registration is required. Typically, the providers 106 are organizers of activities open to the general public and can (but not always) require a registration fee for participation in the activities. In other embodiments, the providers include organizers or facilitators of activities to be made available to a particular community or group of individuals.

In use, the providers 106 access the activity clearinghouse system 102 and create activity records in the activity database 108 describing the activity to be hosted, using one or more user interfaces as described herein. Users 104 can access those activity records, and can register one or more individuals (e.g., individuals 112a-b) for one or more selected activities. The activity clearinghouse system 102 can maintain profiles for the users and individuals such that providers can monitor enrollment for their hosted activities, and users can track individuals' schedules, and can manage a number of additional aspects of activity registration and attendance (e.g., calendars, carpooling, and combined scheduling as described below).

Referring now to FIGS. 2-5 various schematic depictions of functionality hosted by the activity clearinghouse system 102 and activity database 108 are shown. The activity clearinghouse server 102 accesses an activity database 108 containing a plurality of provider profiles 202, user profiles 204, and activity records 206. Additionally, the activity clearinghouse system 102 hosts a provider administration module 212, a user administration module 214, and an event administration module 216.

The provider profiles 202 include information about the provider, such as the name of the provider, the type of provider, and links to example activities (upcoming or historical) hosted by the provider.

The user profiles 204 include information about the user, including billing information/preferences, name, address, and records of individuals associated with the user such that the user profile links to individual activity schedules.

The activity records 206 include a number of provider-defined activity parameters useable to define the activity to allow users to determine whether they may be interested in registering an individual for that activity. Example activity parameters can include age range of the activity, intended skill level, the activity type (e.g., basketball, gymnastics, camp, etc.), activity rules and regulations, activity cost (e.g., registration and fee/equipment costs), activity promotional cost (a short-term or other cost for registration to promote additional registration), registration time period, sport, date(s) of the activity, time of day, duration, frequency (weekly, nightly, etc.), intended gender, and residency. Other activity parameters could be defined in the activity record 206 as well.

The provider administration module 212 manages provider access to the activity clearinghouse system 102, and allows editing and management of the provider profiles 202 described below. The provider administration module 212 can generate a number of user interfaces for use by the provider to allow creation of a provider profile 202 and activity records 206, as well as reports regarding subsequent access/registration actions taken within the activity clearinghouse system 102 with respect to created activity records 206 (e.g., registrations or information views by one or more users).

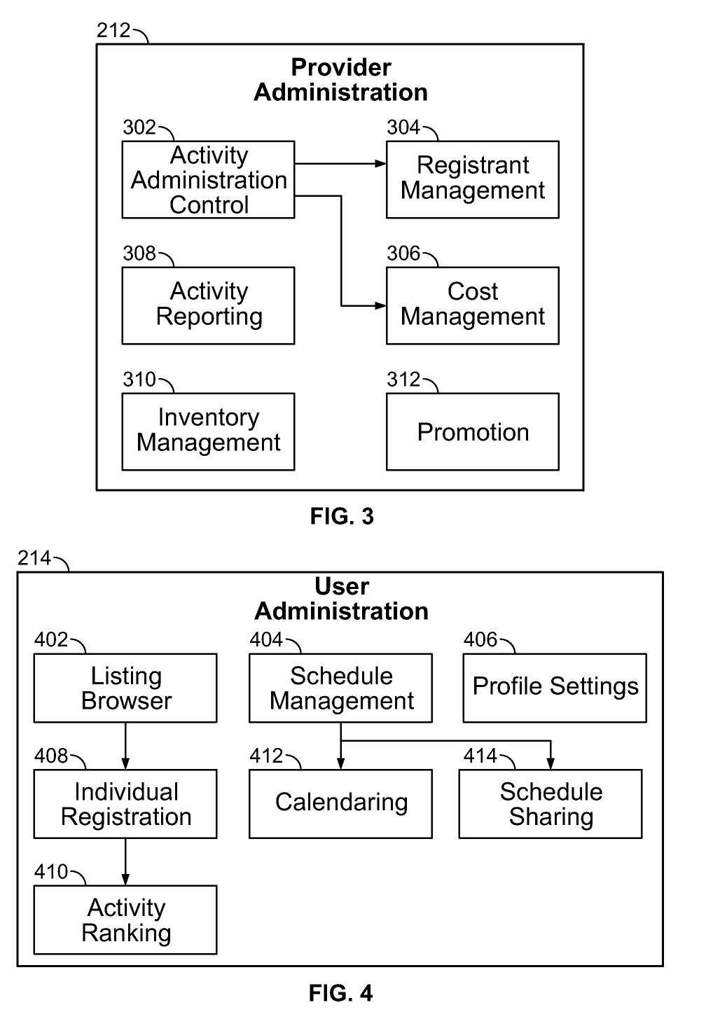

In the embodiment shown in FIG. 3, the provider administration module 212 includes an activity administration control module 302, a registration management module 304, a cost management module 306, an activity reporting module 308, as well as an inventory management module 310 and a promotion module 312.

The activity administration control module 302 provides the provider who created an activity record administrative access to that record, such that the provider can edit any of the activity parameters associated with the activity.

The registration management module 304 manages links between activity records and user profiles, and allows the provider to view and edit information in an activity roster in realtime (as the activity fills, and before or during when the activity is occurring). For example, the registration management module 304 allows the provider to monitor and alter registration prices, or other details in an activity record. The registration management module 304 can, in certain embodiments (e.g., the embodiment shown) depend from the activity administration control module 302 and share functionality to edit activity enrollment information.

Additionally, the cost management module 306 manages collection and redistribution of costs, allowing the provider to set activity costs, collecting registration and other activity fees from a user, and redistributing at least a portion of those fees that corresponds to the activity costs to the provider. The cost management module 306 can optionally recover fees for the administrator of the activity clearinghouse server 102 to cover operational costs or profit from operation of the activity clearinghouse server as well. The cost management module 306 can manage alternative fee or cost sources as well, such as activity fees or fees collected for advertising hosted by the activity clearinghouse server.

The activity reporting module 308 generates reports utilization and other statistics to providers for their use, e.g., to determine whether enrollment in one or more activities is insufficient.

An inventory management module 310 allows adjustment of baseline and maximum enrollment levels, set cancellation policies for use by users, or other settings. The promotion module 312 allows a provider to set a promotional registration cost useable to encourage additional registrations for a particular activity on a limited-time or other limited basis.

Referring again to FIG. 2, the user administration module 214 manages user access to the activity clearinghouse server 102 by authenticating a user with respect to his/her user profile 204, and allows that user to define associated individuals to be registered for activities, register those individuals for activities, manage calendars and scheduling of activities, view activity information and promotions, arrange for sharing of schedules/calendars and arrangement of carpooling with other users for the individuals signed up for a common activity (e.g., for use by parents registering their children for a common activity), or otherwise communicate with other users of the activity clearinghouse server 102 to pass messages between users or individuals associated with those users.

In the embodiment shown in FIG. 4, the user administration module 214 includes a listing browser module 402, a schedule management module 404, and a profile settings module 406.

The listing browser module 402 allows a user to browse activity records, and allows keyword and/or filter-based searching of activities to find appropriate activities according to any of the predefined activity parameters included in the activity record. The listing browser module 402 links to a registration module 408 and an activity ranking module 410.

The registration module 408 allows the user to register an individual (e.g. the user, a child associated with the user, or some other individual) for an activity by linking the individual (as a portion of the user profile) with an activity record. Optionally, the registration module 408 causes operation of a provider module such as the cost management module 306 to charge the user accordingly for registering an individual with the activity.

The activity ranking module 410 allows a user to optionally rank preferences among multiple activities selected, such that the user can register an individual for a number of conflicting activities and the activity clearinghouse system 102 can confirm registration of that individual in a highest-ranked preference activity only.

The schedule management module 404 allows user management of schedules for individuals registered for activities using the activity clearinghouse system. The schedule management module 404 allows a user to edit view schedules of individuals associated with various activities. The schedule management module 404 links to a calendaring module 412 and a schedule sharing module 414.

The calendaring module 412 generates a calendar view for use by the user, which can include a display of activities of one or more of the individuals associated with that user. The schedule sharing module 414 allows users to share schedules of registered activities of one or more individuals with another registered user of an activity clearinghouse system. The shared schedule can include transmission of a calendar view, an activity listing view, a link to one or both types of views, or other shared schedule arrangement.

The profile settings module 406 allows user editing of settings within the user profile. The settings editable by the user can include, in various embodiments, user contact and billing information. Other types of settings (e.g. emergency contacts or other information) can be included as well.

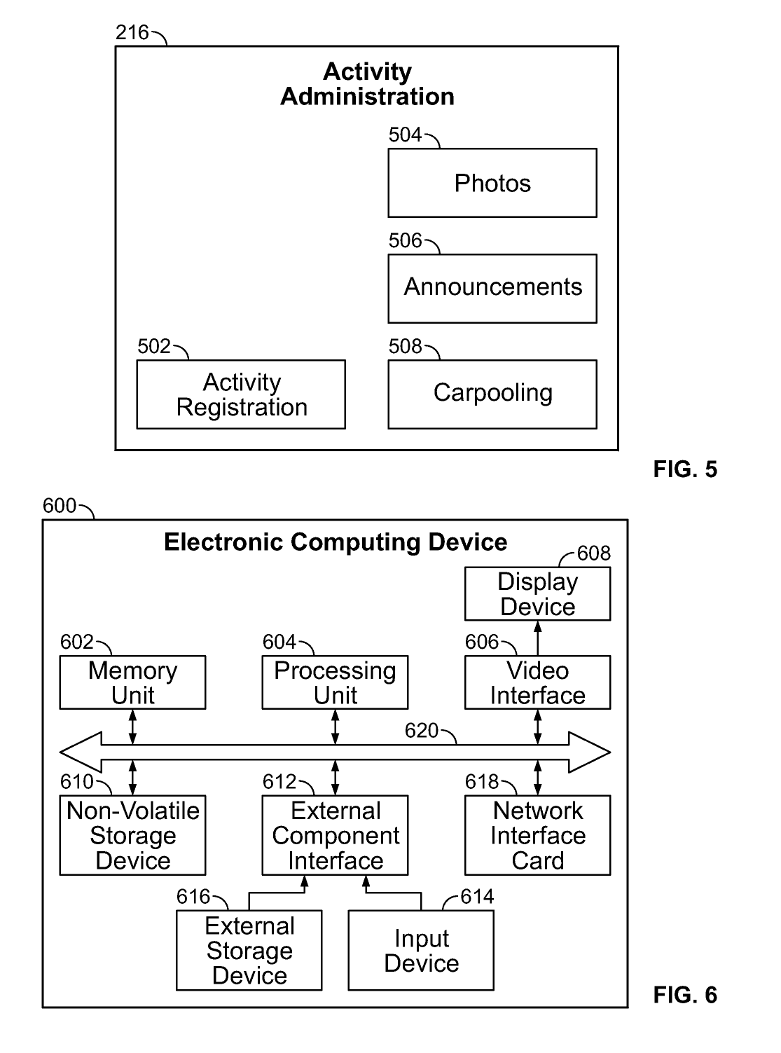

The activity administration module 216 manages access to and editing of data items specific to a particular activity and for which common data is not required. In the embodiment shown in FIG. 5, the activity administration module 216 includes an activity registration module 502, a photographs module 504, an announcements module 506, and a carpooling module 508.

The activity registration module 502 manages links from users and/or individuals to a particular activity from the perspective of the activity. The activity registration module 502 therefore manages an activity roster, and can be accessed by providers and/or users.

The photographs module 504 allows upload of photographs associated with a particular activity. In certain embodiments, users can only access photographs via the photographs module that the user has uploaded; in other embodiments, users can access all photographs uploaded by users associated with that activity.

The announcements module 506 manages and displays announcements associated with a particular activity, such as notations regarding equipment required, unexpected delays or cancellations (e.g., via weather), or other informational announcements. The announcements module 506 can be executed by a provider to create an announcement associated with that provider's activity, and can be accessed by a user to view announcements associated with activities that the user has registered an individual for. Other configurations and operations of the announcements module 506 are possible as well.

The carpooling module 508 facilitates carpooling between users having registered individuals in a common activity. The carpooling module 508 can request whether an individual is willing to carpool, and can display available carpooling individuals, e.g. organized by geographical area. Upon formation of a carpool, the carpooling module 508 links carpools and shares information among users within that formed carpool (e.g. scheduling and/or address and contact information).

In alternative embodiments, the carpooling module 508 can allow further types of messages to be transmitted between users of the activity clearinghouse server. For example the carpooling module can be more generally referred to as a messaging module, and could provide functionality that would allow users to display other types of messages to each other relating to activities or in general for external (e.g., non-activity) messaging.

Additional functionality can be included in the activity clearinghouse server 102, and additional records can be stored in the activity database 108 as well. Furthermore, although specific functionality and relationships between functional modules are described in the present disclosure, it is understood that additional or alternative arrangements could be used as well.

FIG. 6 is a block diagram illustrating example physical components of an electronic computing device 600. The electronic computing device 600 can be used to implement one or more features of the activity clearinghouse system 102 or other components of the activity registration network 100, described above in connection with FIGS. 1-5.

A computing device, such as electronic computing device 600, typically includes at least some form of computer-readable media. Computer readable media can be any available media that can be accessed by the electronic computing device 600. By way of example, and not limitation, computer-readable media might comprise computer storage media and communication media.

As illustrated in the example of FIG. 6, electronic computing device 600 comprises a memory unit 602. Memory unit 602 is a computer-readable data storage medium capable of storing data and/or instructions. Memory unit 602 may be a variety of different types of computer-readable storage media including, but not limited to, dynamic random access memory (DRAM), double data rate synchronous dynamic random access memory (DDR SDRAM), reduced latency DRAM, DDR2 SDRAM, DDR3 SDRAM, Rambus RAM, or other types of computer-readable storage media.

In addition, electronic computing device 600 comprises a processing unit 604. As mentioned above, a processing unit is a set of one or more physical electronic integrated circuits that are capable of executing instructions. In a first example, processing unit 604 may execute software instructions that cause electronic computing device 600 to provide specific functionality. In this first example, processing unit 604 may be implemented as one or more processing cores and/or as one or more separate microprocessors. For instance, in this first example, processing unit 604 may be implemented as one or more Intel Core 2 microprocessors. Processing unit 604 may be capable of executing instructions in an instruction set, such as the x86 instruction set, the POWER instruction set, a RISC instruction set, the SPARC instruction set, the IA-64 instruction set, the MIPS instruction set, or another instruction set. In a second example, processing unit 604 may be implemented as an ASIC that provides specific functionality. In a third example, processing unit 604 may provide specific functionality by using an ASIC and by executing software instructions.

Electronic computing device 600 also comprises a video interface 606. Video interface 606 enables electronic computing device 600 to output video information to a display device 608. Display device 608 may be a variety of different types of display devices. For instance, display device 608 may be a cathode-ray tube display, an LCD display panel, a plasma screen display panel, a touch-sensitive display panel, a LED array, or another type of display device.

In addition, electronic computing device 600 includes a non-volatile storage device 610. Non-volatile storage device 610 is a computer-readable data storage medium that is capable of storing data and/or instructions. Non-volatile storage device 610 may be a variety of different types of non-volatile storage devices. For example, non-volatile storage device 610 may be one or more hard disk drives, magnetic tape drives, CD-ROM drives, DVD-ROM drives, Blu-Ray disc drives, or other types of non-volatile storage devices.

Electronic computing device 600 also includes an external component interface 612 that enables electronic computing device 600 to communicate with external components. As illustrated in the example of FIG. 6, external component interface 612 enables electronic computing device 600 to communicate with an input device 614 and an external storage device 616. In one implementation of electronic computing device 600, external component interface 612 is a Universal Serial Bus (USB) interface.

In other implementations of electronic computing device 600, electronic computing device 600 may include another type of interface that enables electronic computing device 600 to communicate with input devices and/or output devices. For instance, electronic computing device 600 may include a PS/2 interface. Input device 614 may be a variety of different types of devices including, but not limited to, keyboards, mice, trackballs, stylus input devices, touch pads, touch-sensitive display screens, or other types of input devices. External storage device 616 may be a variety of different types of computer-readable data storage media including magnetic tape, flash memory modules, magnetic disk drives, optical disc drives, and other computer-readable data storage media.

In the context of the electronic computing device 600, computer storage media includes volatile and nonvolatile, removable and non-removable media implemented in any method or technology for storage of information such as computer readable instructions, data structures, program modules or other data. Computer storage media includes, but is not limited to, various memory technologies listed above regarding memory unit 602, non-volatile storage device 610, or external storage device 616, as well as other RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the electronic computing device 600.

In addition, electronic computing device 600 includes a network interface card 618 that enables electronic computing device 600 to send data to and receive data from an electronic communication network. Network interface card 618 may be a variety of different types of network interface. For example, network interface card 618 may be an Ethernet interface, a token-ring network interface, a fiber optic network interface, a wireless network interface (e.g., WiFi, WiMax, etc.), or another type of network interface.

Electronic computing device 600 also includes a communications medium 620. Communications medium 620 facilitates communication among the various components of electronic computing device 600. Communications medium 620 may comprise one or more different types of communications media including, but not limited to, a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computer System Interface (SCSI) interface, or another type of communications medium.

Communication media, such as communications medium 620, typically embodies computer-readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

Electronic computing device 600 includes several computer-readable data storage media (i.e., memory unit 602, non-volatile storage device 610, and external storage device 616). Together, these computer-readable storage media may constitute a single data storage system. As discussed above, a data storage system is a set of one or more computer-readable data storage mediums. This data storage system may store instructions executable by processing unit 604. Activities described in the above description may result from the execution of the instructions stored on this data storage system. Thus, when this description says that a particular logical module performs a particular activity, such a statement may be interpreted to mean that instructions of the logical module, when executed by processing unit 604, cause electronic computing device 600 to perform the activity. In other words, when this description says that a particular logical module performs a particular activity, a reader may interpret such a statement to mean that the instructions configure electronic computing device 600 such that electronic computing device 600 performs the particular activity.

One of ordinary skill in the art will recognize that additional components, peripheral devices, communications interconnections and similar additional functionality may also be included within the electronic computing device 600 without departing from the spirit and scope of the present disclosure.

As described above, the users 104 and the providers 106 can use one or more computing devices to communicate with the system 102. In example embodiments, the users 103 and providers 106 can user one or more computing devices configured in a manner similar to that of the electronic computing device 600 described above to do so.

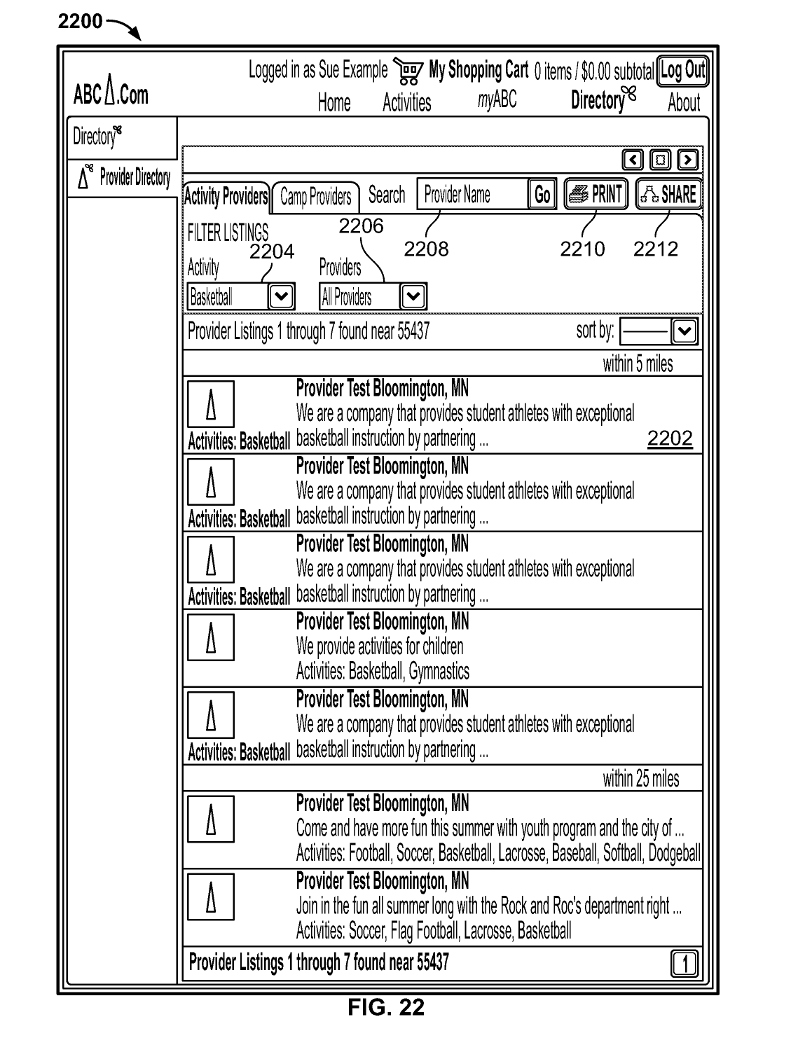

Referring now to FIGS. 7-37, various user interfaces are described that can be generated by an activity clearinghouse system and used by activity providers and users to create and manage activity registrations in a centralized, coordinated manner. The user interfaces can be, for example, generated using the hardware and system modules described above in connection with FIGS. 1-6, and expose the various records stored in an activity database, including provider profiles, user profiles, and activity records. FIG. 7-21 illustrate user interfaces useable by a provider (e.g. provider 106 of FIG. 1) to create an account with an activity clearinghouse system, as well as manage activities and user registrations for those activities. These user interfaces can be generated, in various embodiments, by the provider administration module 212 and/or the activity administration control module 216 described above. FIGS. 22-37 illustrate user interfaces useable by a user (e.g. user 104 of FIG. 1) to manage activities for one or more individuals associated with that user (e.g. individuals 112a-b of FIG. 1). These user interfaces can be generated, in various embodiments, by the user administration module 214 and/or the activity administration control module 216 described above.

FIG. 7 illustrates an example user interface 700 displaying a provider account summary for a provider registered with an activity clearinghouse system, according to a possible embodiment of the present disclosure. The user interface 700 includes a fee summary region 702 and a transaction region 704. The fee summary region 702 displays a summary of fees collected by the activity clearinghouse system and disbursed to the provider for selectable dates. Date range fields 706a-b allow the provider to define the date range for which the summary applies. A print button 708 allows the provider to print the summary of financial information displayed in the fee summary region 702. An export button 710 allows the provider to export the summary of financial information for use on a local computing system (e.g. in a text file or spreadsheet format).

The transaction region 704 displays transactions occurring within a selectable time period. Although in the embodiment shown no transactions are listed, the transactions can include any of a number of different types of entries, such as transactions by the provider (e.g. creating new listings, editing listings, or creating promotions), or transactions by users that are relevant to that provider (e.g. a user signing an individual up for an activity hosted by the provider). Date range fields 712a-b allow the provider to define the date range for which the transaction display applies. A search field 714 allows the provider to search for a particular transaction stored by the activity clearinghouse system (e.g. in the activity database 108). A print button 716 and an export button 718 provide analogous functionality to the buttons 708, 710 above, but with respect to the transaction region 704 rather than the fee summary region 702.

In alternative embodiments, only a single set of date range fields is provided in the user interface 700, and is used to define date ranges for both the fee summary region 702 and the transaction region 704. In still other embodiments, a single print button or a single export button is included on the user interface, and is used to print or export data from both regions 702, 704. Other configurations are possible as well.

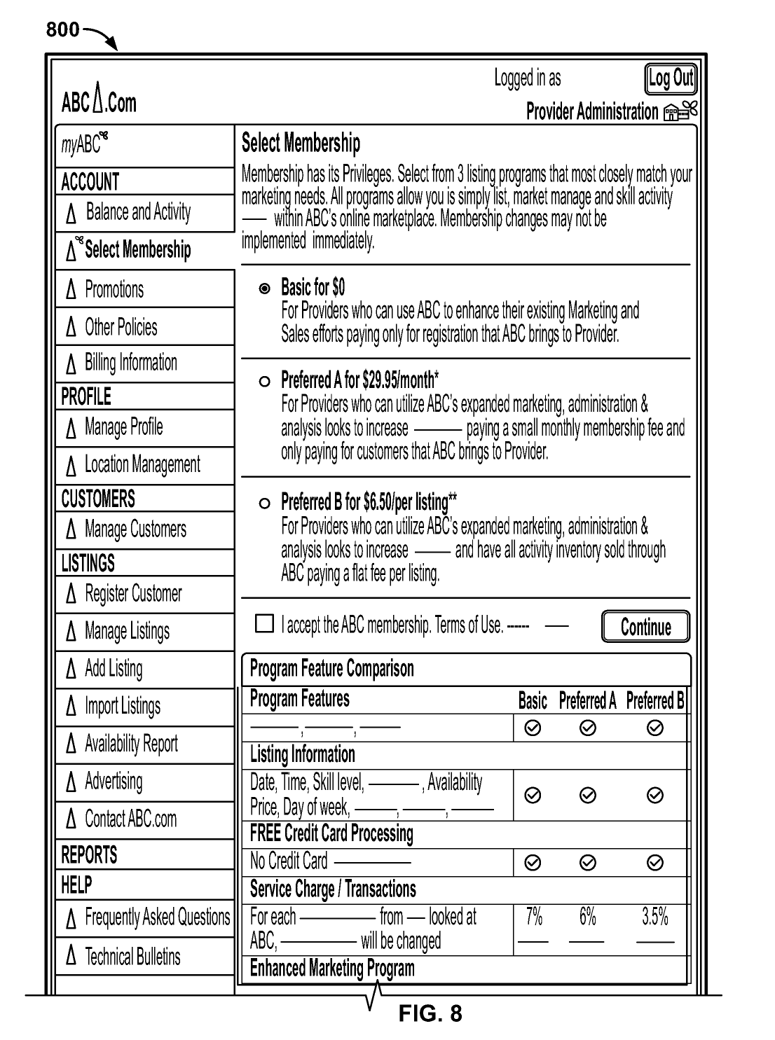

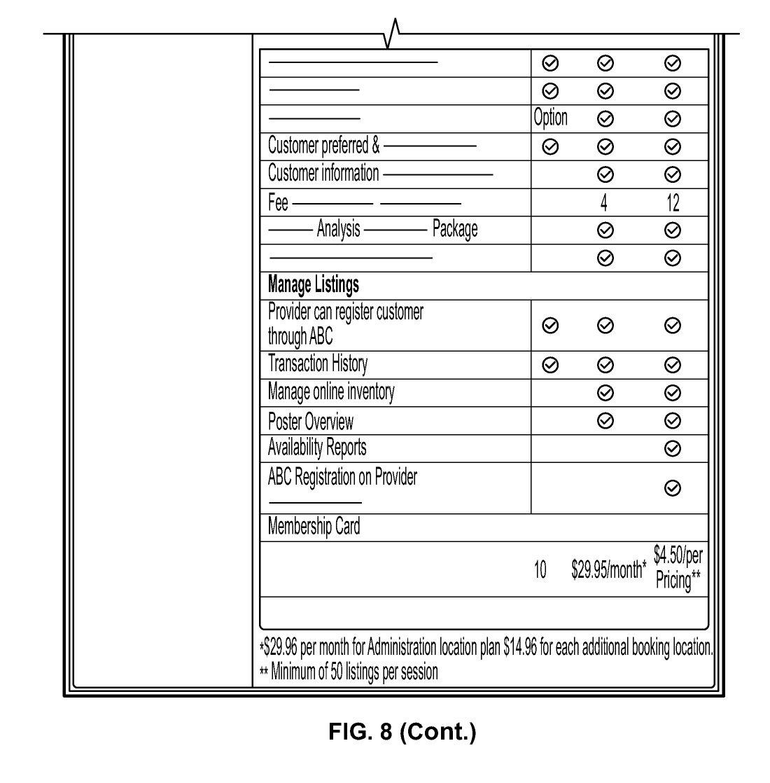

FIG. 8 illustrates an example user interface 800 displaying activity provider membership selection options. The user interface 800 allows a provider to select a particular combination of options that they wish to access via the activity clearinghouse system. In the embodiment shown, three different example membership levels are available to a provider, each of which requires a different type of fee arrangement. For example, a first level allows a user to perform basic tasks such as creating activities and making those activities available to users, while a second level also allows generation of an activity roster or manage an activity inventory, or manage revenues. A third level allows all of the functionality of the previous two levels and also provides availability reports and activity registration via the provider's website (rather than being redirected to the activity clearinghouse system). The user interface 800 includes a selection region 802 allowing the provider to select one of the available membership levels.

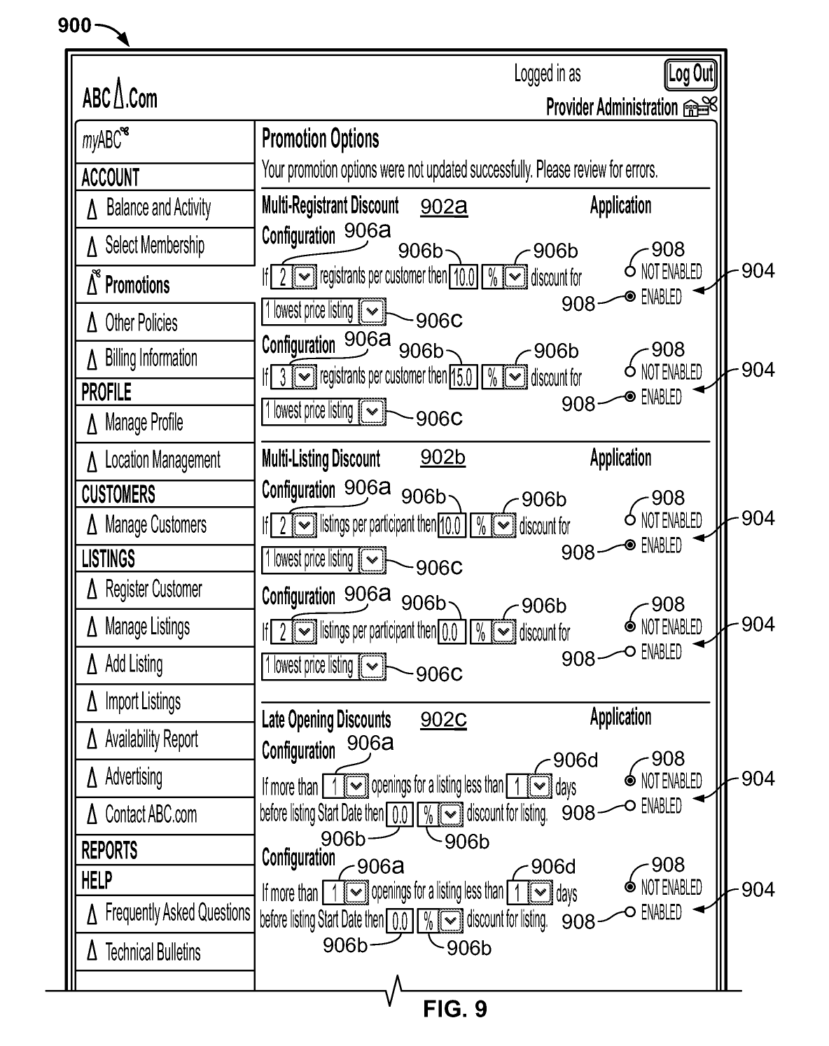

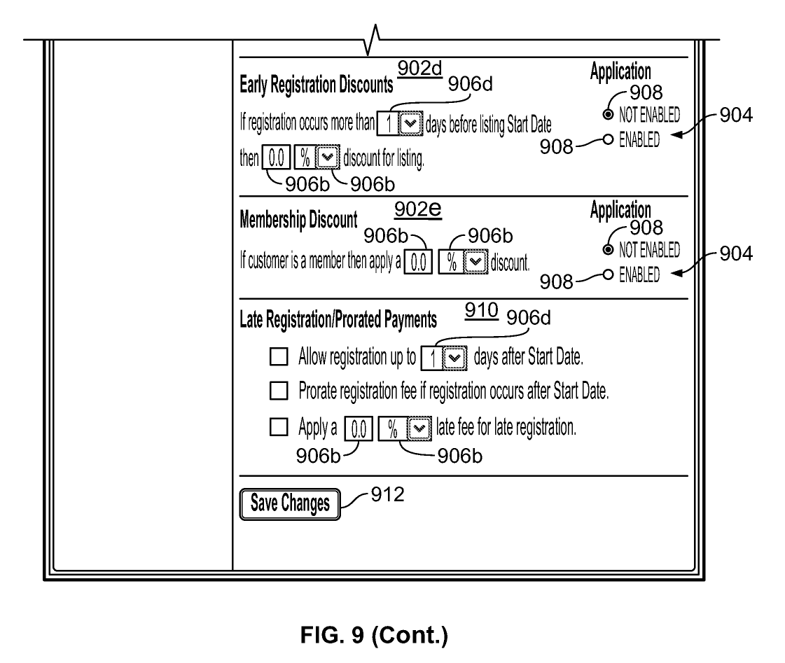

FIG. 9 illustrates an example user interface 900 displaying promotion settings useable by an activity provider. The user interface 900 allows a provider to set one or more types of promotions, providing a discount to a user for various types of activity registrations. The user interface 900 can allow the provider to define promotions of a variety of types, for example relating to the number of registrants, the number of activity registrations per individual participant, the amount of time before a start date, early activity registrations, and membership discounts.

In the embodiment shown, the user interface 900 includes a number of promotional regions 902 including a multi-registrant discount region 902a, a multi-listing discount region 902b, a late opening discount region 902c, an early registration discount region 902d, and a membership discount region 902e. Each of these regions can include different discount or promotional definition entries 904 which can include, for example, a rule entry 906a, a discount amount entry 906b (selectable between a flat rate or percentage discount of a provider-definable amount), and a limitation entry 906c. Additional definitional portions of the definition entries 904 can include a duration entry 906d. Each region also includes one or more enablement selection buttons 908 allowing the provider to enable the selected promotion. In the embodiment shown, the multi-registrant discount region 902a, multi-listing discount region 902b, and late opening discount region 902c have two separate promotion definition entries, allowing a provider to create a multi-tier discounting promotion arrangement in which a first promotion exists for a first level or threshold of user purchases, and a second promotion (e.g. a deeper discount or some other incentive) exists at a second level or threshold. In alternative embodiments, more or fewer of the regions 902 can include multiple tiers of promotions.

Additionally, the user interface 900 allows a provider to define surcharges for late registration, payment, or to accept prorated payment of activity fees by users. A late fee region 910 includes a number of provider-definable rules for late payments, including in the embodiment shown a definition of a number of days late to accept registration (after the activity has started), an option of whether to prorate payments for registrants joining an activity after the start date, and an option of whether to apply a late fee or surcharge for late registration. The definitions included in the late fee region 910 can include analogous rules and can be selected or deselected, allowing optional use of late registration fee surcharges. Other surcharges are possible as well.

A save option 912 allows the provider to save changes to any of the promotional regions 902 or the late fee region 910.

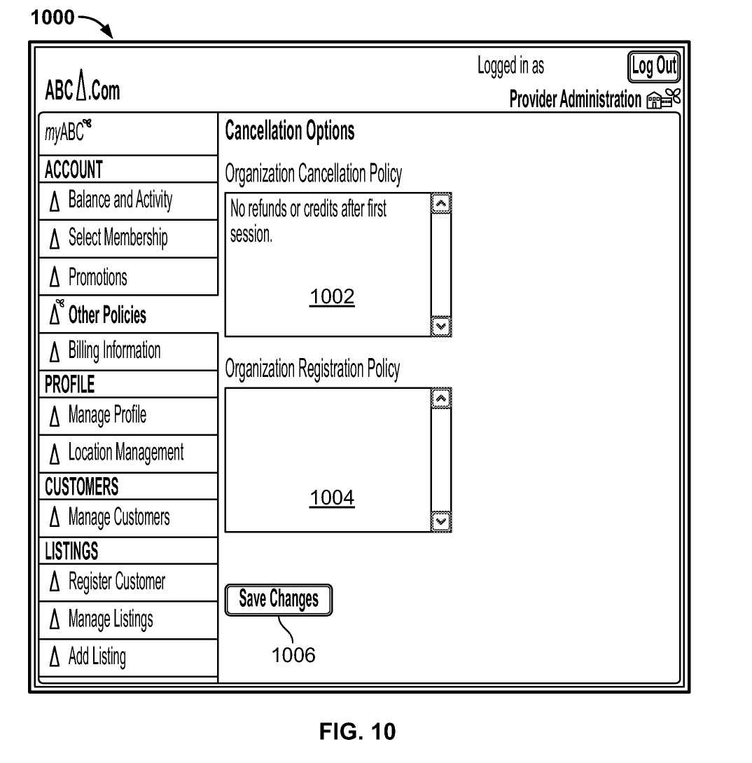

FIG. 10 illustrates a user interface 1000 displaying activity provider policy notes. The user interface 1000 includes, in the embodiment shown, a cancellation policy field 1002 and a registration policy field. 1004. The cancellation policy field 1002 allows the provider to enter notes regarding that provider's cancellation policy with respect to the activities it hosts, while the registration policy field 1004 allows the provider to define registration policies specific to that provider. A save changes button 1006 allows the provider to preserve, alongside a provider profile (e.g., provider profile 202 of FIG. 2) this activity policy information. In alternative embodiments, additional policy fields could be included in the user interface 1000 as well.

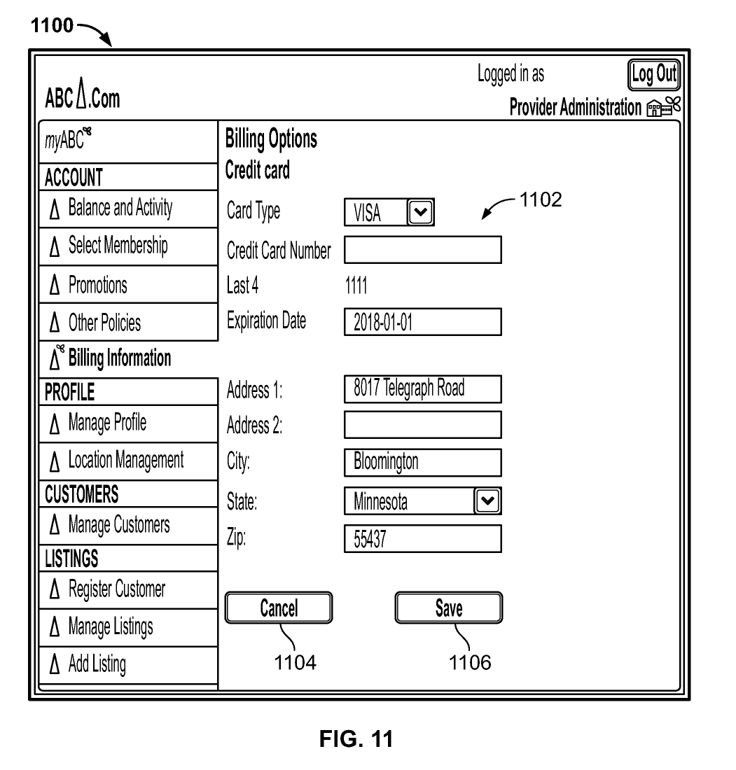

FIG. 11 illustrates a user interface 1100 displaying activity provider billing options. The user interface includes a credit card information form 1102, including a number of provider-editable fields relating to credit card entry information, as well as mailing address or other contact information. A cancel button 1104 allows the provider to cancel edits to this information in the form 1102, and a save button 1106 allows preserving of the information in the credit card information form alongside or within the provider profile.

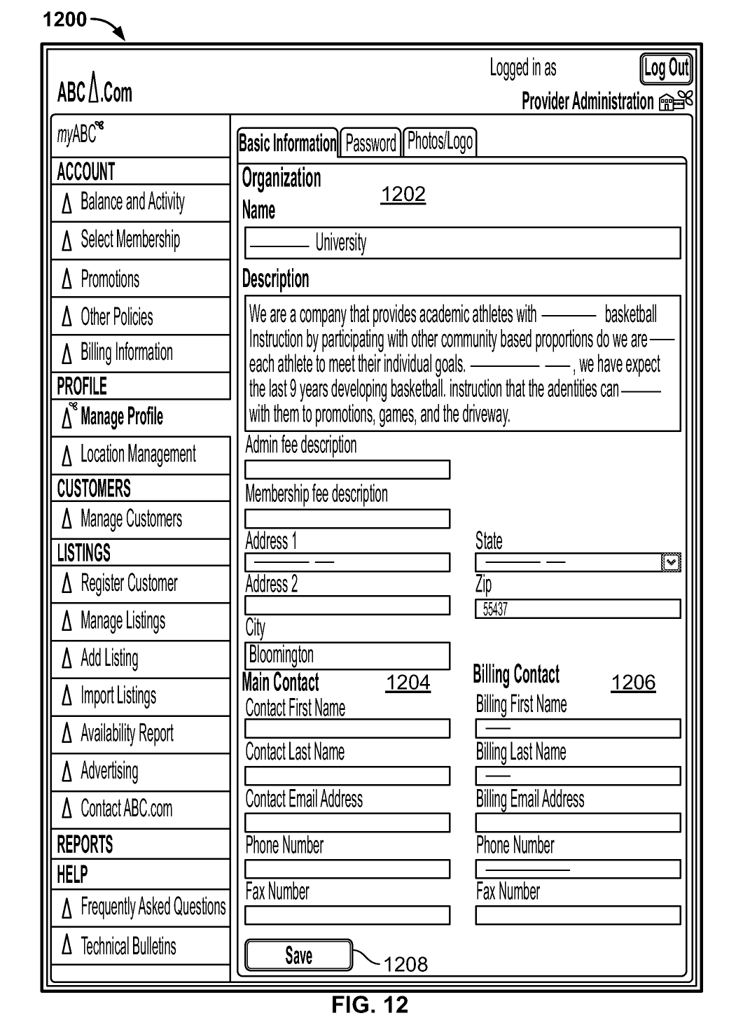

FIGS. 12-14 illustrate user interfaces for setting information stored in a provider profile associated with an activity clearinghouse system, such as the provider profile 202 of FIG. 2, above. FIG. 12 illustrates a user interface 1200 displaying activity provider profile settings. The user interface 1200 includes a number of information entry regions relating to the provider, including organization information 1202, contact information 1204, and billing contact information 1206. The organization information 1202 includes one or more fields relating to the description of the organization, including the organization name, description of the organization, and address of the organization. Additionally, the organization information 1202 includes descriptions of the administration fee and membership fee. The contact information 1204 includes information relating to an individual representing the provider, including a name, email address, phone number, and fax number of that individual. The billing contact information 1206 includes contact information relating to an individual responsible for billing inquiries for the provider, and also includes name, email address, phone number, and fax number. A save button 1208 allows the provider to save the profile settings.

Additional information can be incorporated into the user interface 1200 as well, for setting activity provider profile settings. For example, a form could be provided for upload of forms to the activity clearinghouse server, and linking that form to one or more activities of the provider. The form could be, for example, a release form or other information to be provided to a user viewing the activity as presented by the activity clearinghouse server. Other information and settings could be included into the user interface 1200 as well.

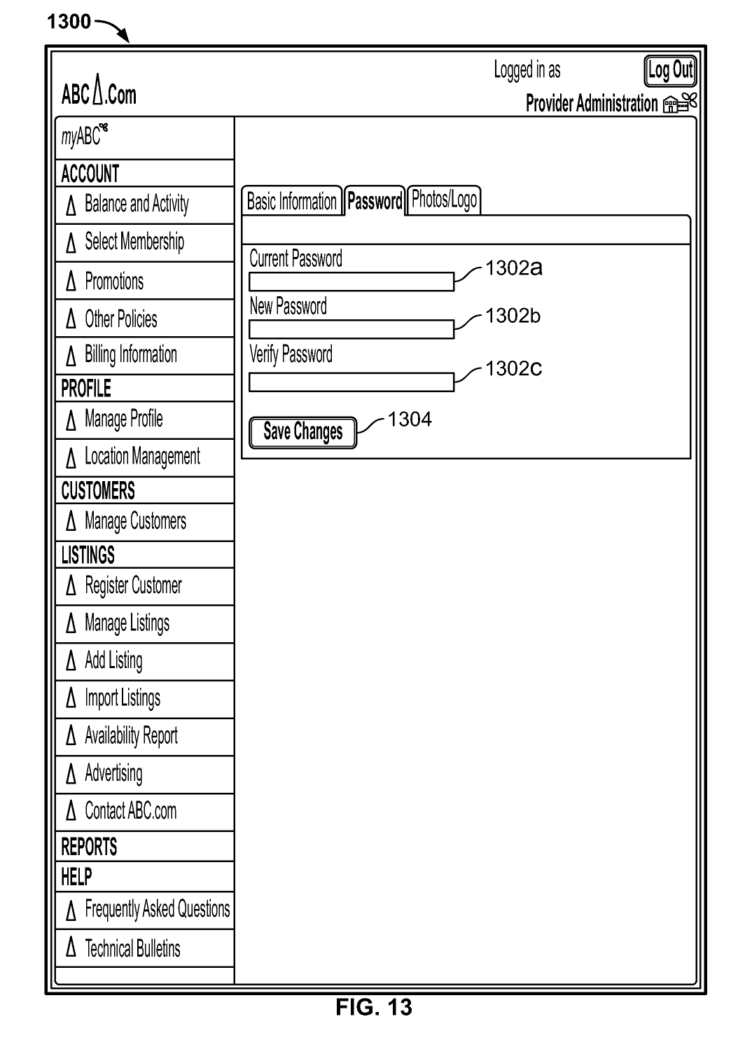

FIG. 13 illustrates a user interface 1300 displaying activity provider password settings. The user profile includes a plurality of password fields 1302a-c useable to enter current and new passwords (fields 1302a and 1302b, respectively), as well as to confirm the new password (field 1302c). A save button 1304 allows the provider to save the entered password information.

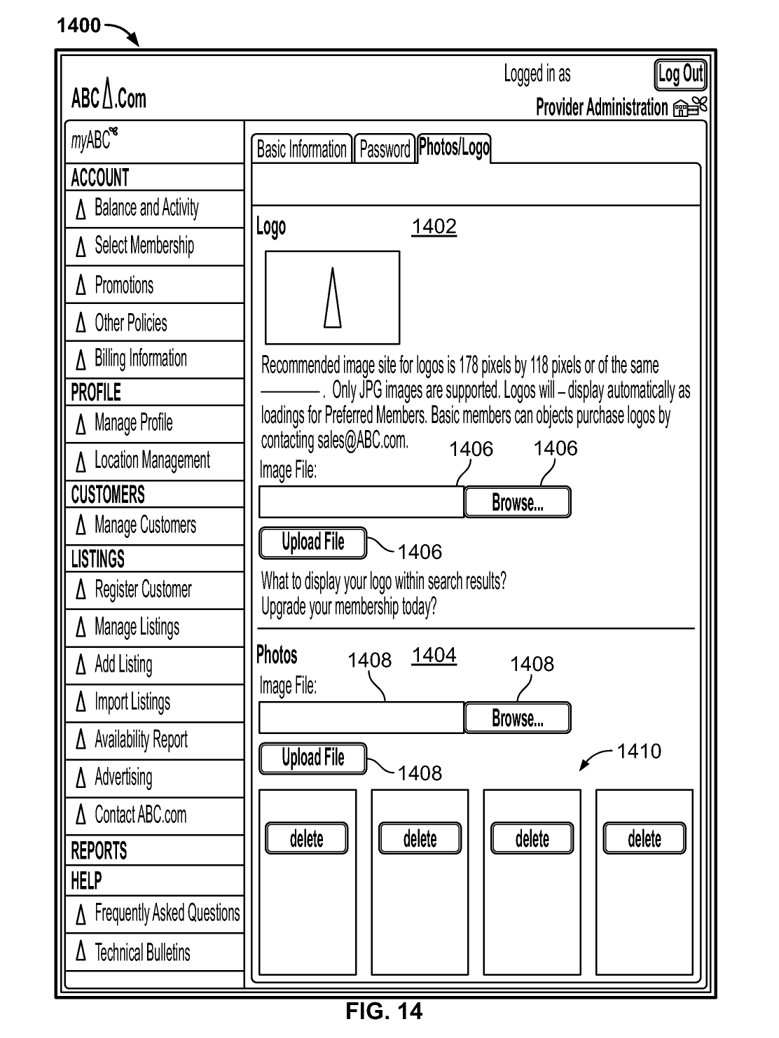

FIG. 14 illustrates a user interface 1400 displaying additional activity provider profile settings. The user interface 1400 includes a logo upload region 1402 and a photographs region 1404. The logo upload region includes a display of a logo associated with the provider, and includes a file browser 1406 capable of allowing a provider to select and upload a picture useable by the activity provider as that provider's recognizable logo. The photographs region 1404 allows the provider to upload representative photographs for activities associated with that provider to an activity clearinghouse. The photographs region includes an image uploader 1408 and a thumbnail viewer 1410. The image uploader allows the provider to select photographs for upload, while the thumbnail view 1410 allows display of a small version of each photograph. Other fields can be included as well.

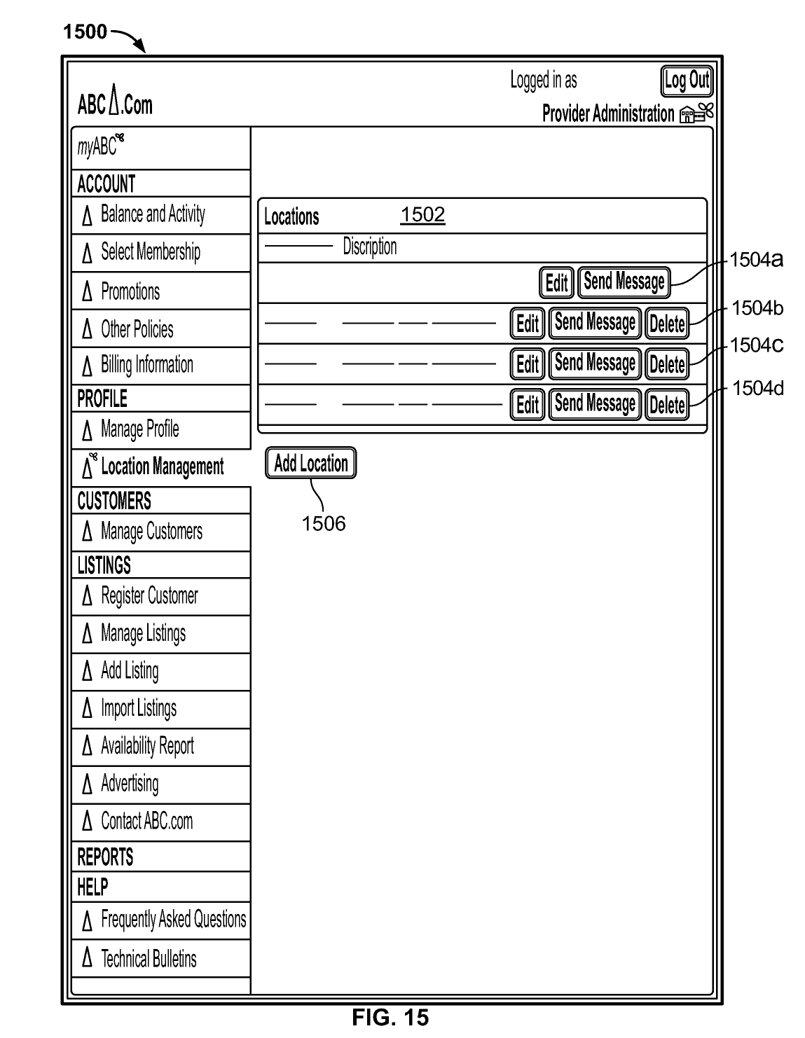

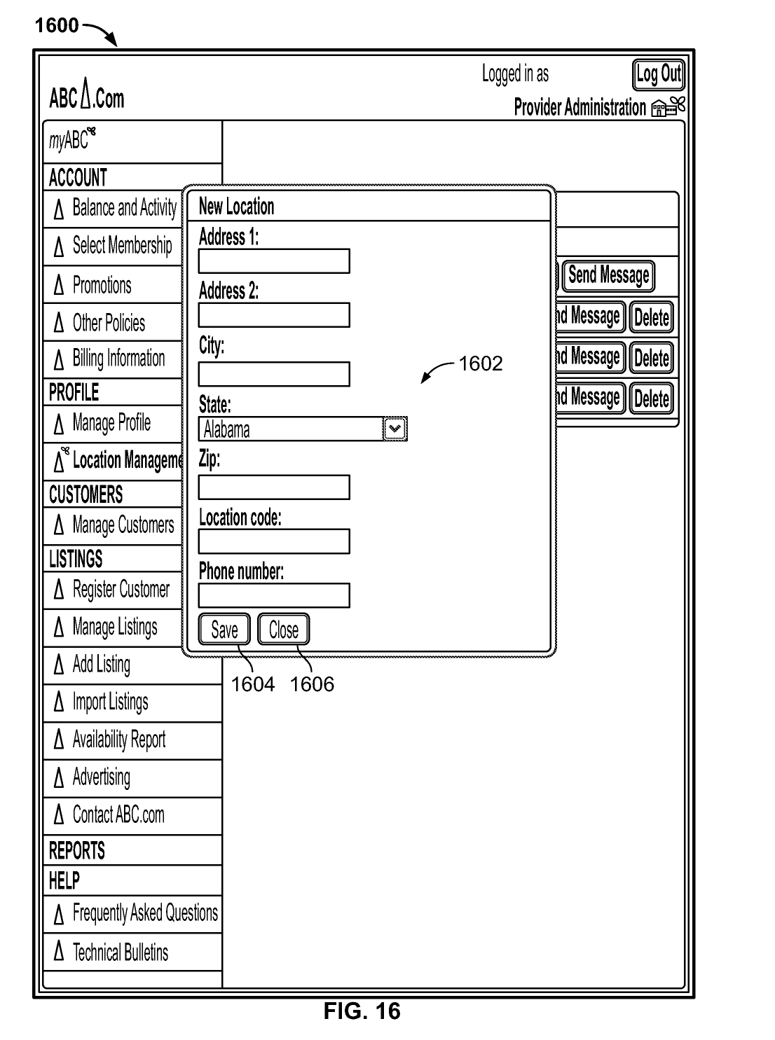

FIG. 15 illustrates a user interface 1500 displaying activity provider location settings. The user interface 1500 allows a user to define one or more location listings at which the provider hosts activities. The user interface 1500 includes a location listing region 1502 showing those location listings, shown as listings 1504a-d; in the embodiment shown, four location listings are associated with the current provider. Each location listing 1504 includes a description of the location, as well as buttons allowing editing, deletion, or sending a message regarding the selected location. An add location button 1506 allows the provider to define a further location (e.g., as shown in FIG. 16).

FIG. 16 illustrates a user interface 1600 for adding or editing locations displayed in FIG. 15. The user interface 1600 allows a provider to define a new location for the location listing region 1502, or edit a listing (e.g. as selected using an edit location button in a location listing or following selection of the add location button 1506). The user interface 1600 includes a plurality of location fields 1602, including address, city, state, zip code, location code, and phone number fields. Other fields are possible as well. Additionally, a save button 1604 saves changes to the location details added in the fields of the user interface 1600, and a close button 1606 exits the user interface 1600, returning to the user interface 1500 without changes to any of the locations.

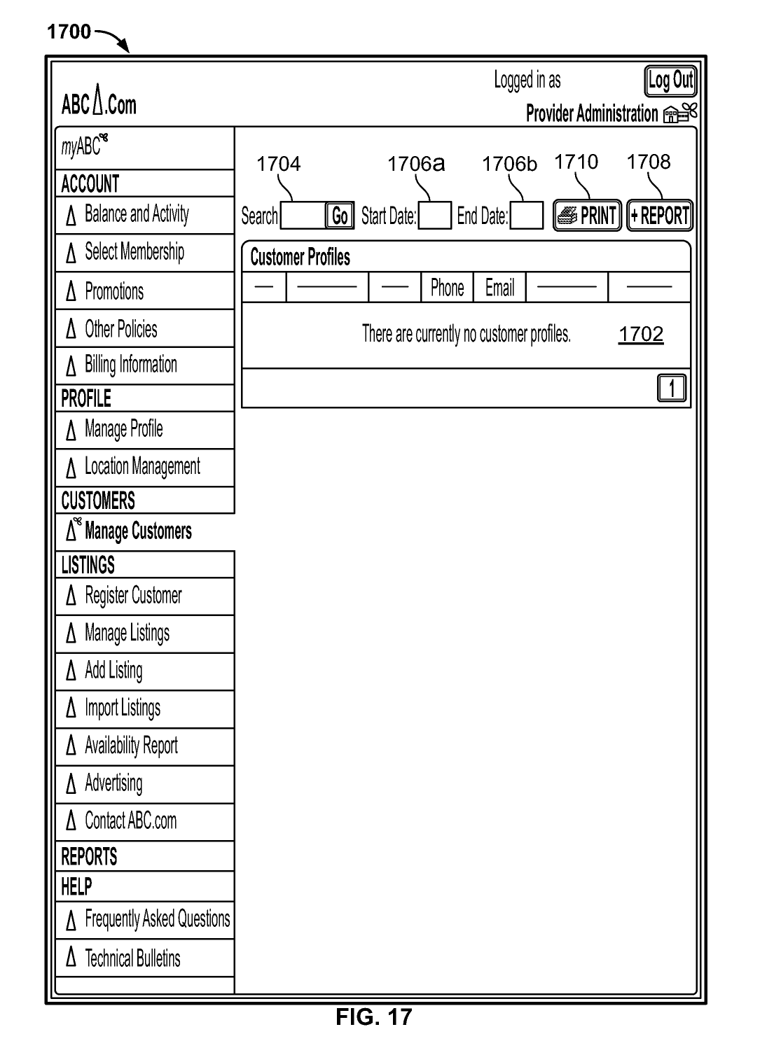

FIG. 17 illustrates a user interface 1700 displaying customer profiles to an activity provider. The user interface 1700 allows the provider to search for and view customer profiles associated with activities hosted by the provider. The customer profiles generally correspond to users of an activity clearinghouse system who have registered for activities hosted by the provider. The user interface 1700 includes a user listing region 1702 used to list customer profiles matching search criteria. The user interface 1700 also includes a search field 1704 allowing the provider to keyword search user profiles, as well as start and end date fields 1706a-b used to define a date range for the customer interaction (e.g., registration for an activity hosted by the provider). A print button 1708 allows the provider to print the search results, and an export button 1710 allows the provider to export a file to a computing system local to the provider (e.g. a text file or a spreadsheet file). Other regions and buttons can be included in the user interface 1700 as well to extend the search functionality of the system.

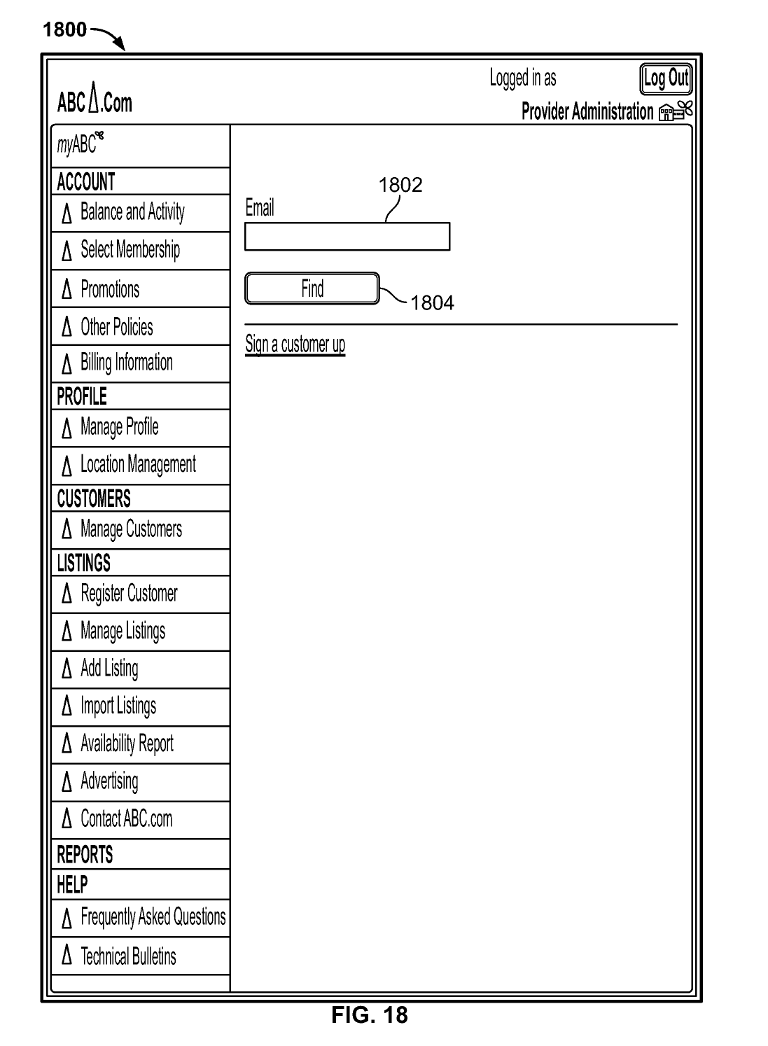

FIG. 18 illustrates a further user interface 1800 displaying a customer search form useable by an activity provider. The user interface 1800 includes a search field 1802 in which a provider can type an email address, and a find button 1804 useable in conjunction with the search field 1802 to locate a particular user/customer of that provider.

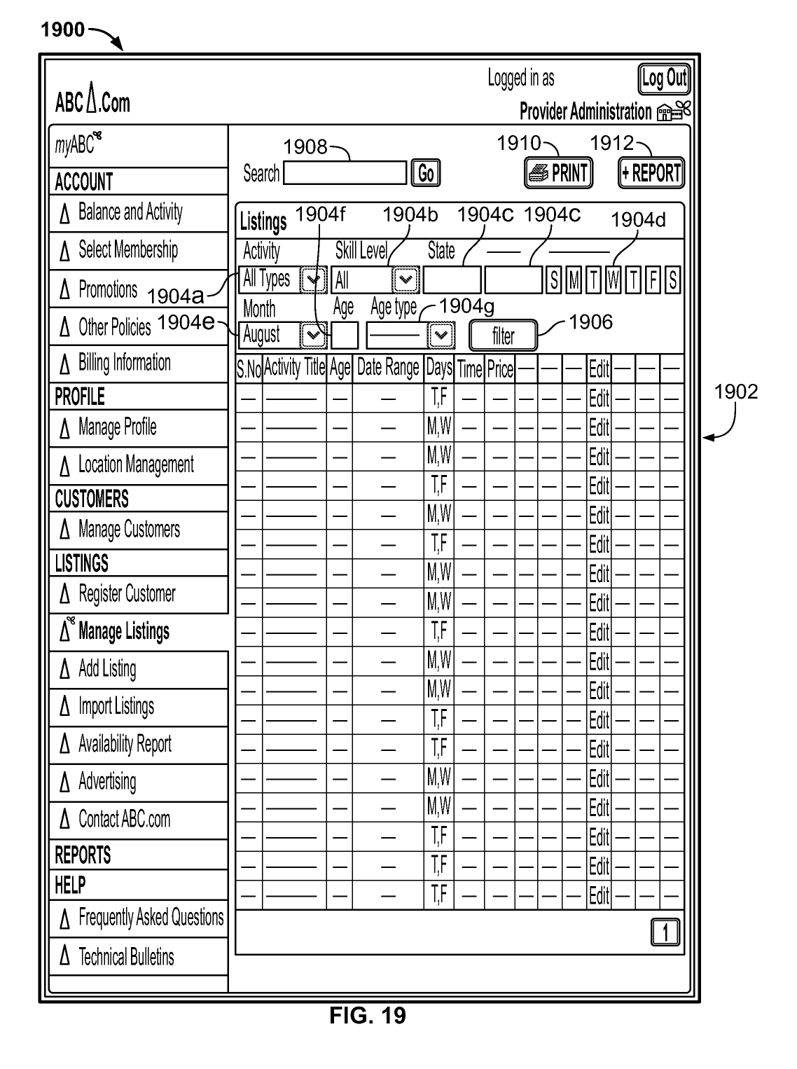

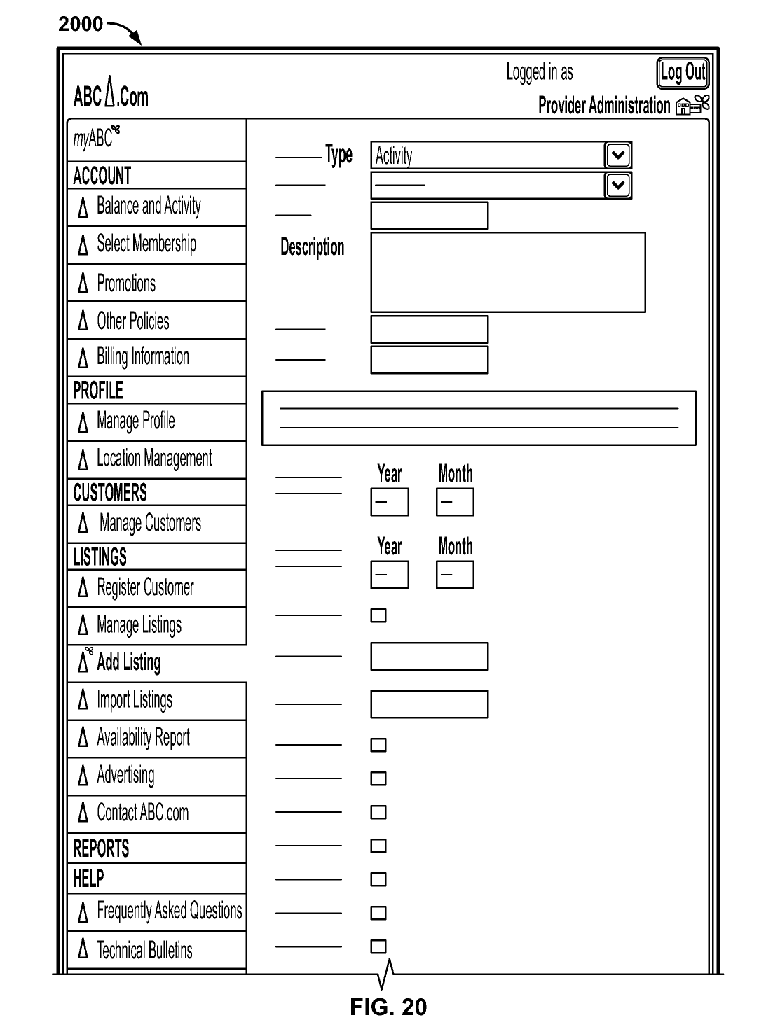

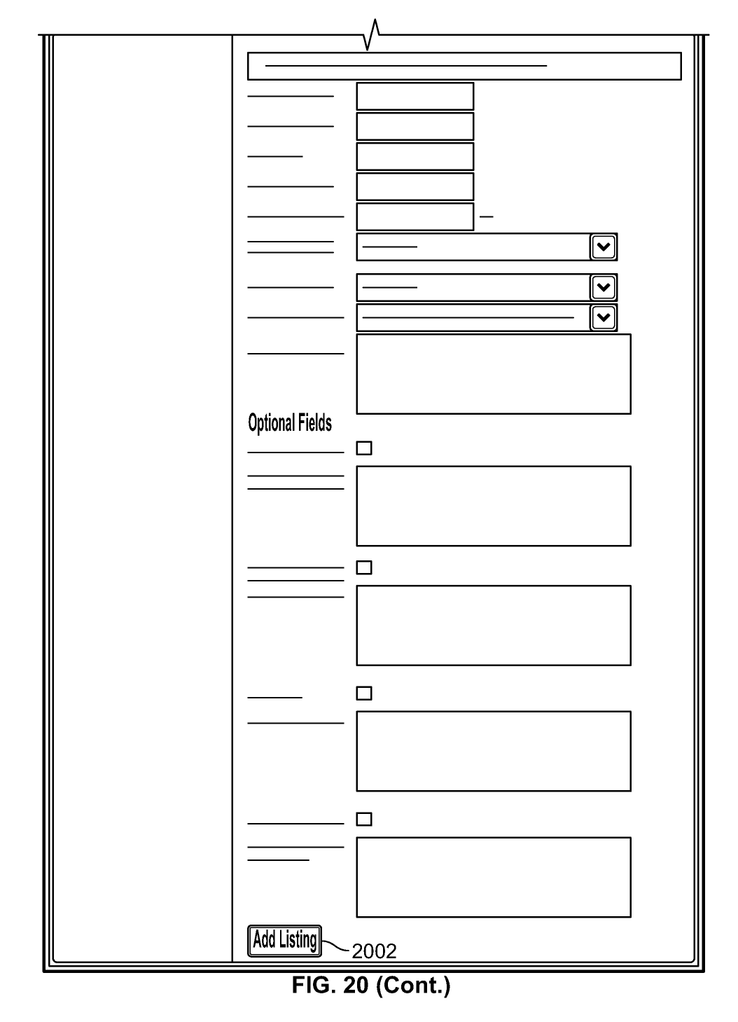

FIG. 19 illustrates a user interface 1900 displaying activity listings managed by an activity provider. The user interface 1900 includes an activity listing region 1902 that displays activity listings associated with the provider. Each activity listing includes various details regarding an activity record defined by the provider (e.g. in an activity record as can be defined using the user interface 2000 of FIG. 20, below). The details can include, for example, the type of activity, activity title, intended age, date range, days of the week, times of the day, registration price, available inventory of positions in the activity, location, status (active, closed, etc.), and various links to edit, close, delete, or clone a selected activity. The user interface includes a plurality of filters 1904 useable to narrow the listing of activities in the activity listing region 1902, including an activity filter 1904a, a skill filter 1904b, a date range filter 1904c, a day of week filter 1904d, a meeting time filter 1904e, an age filter 1904f, an age type filter 1904g, and a filter button 1906 useable to trigger operation of the selected filters.

A search field 1908 allows the provider to search for one or more particular listings, while a print button 1910 allows the user to print the current listing of activities. An export button 1912 allows export of a file (e.g., in a flat file or spreadsheet format) useable on a computing system remote from the activity clearinghouse system.

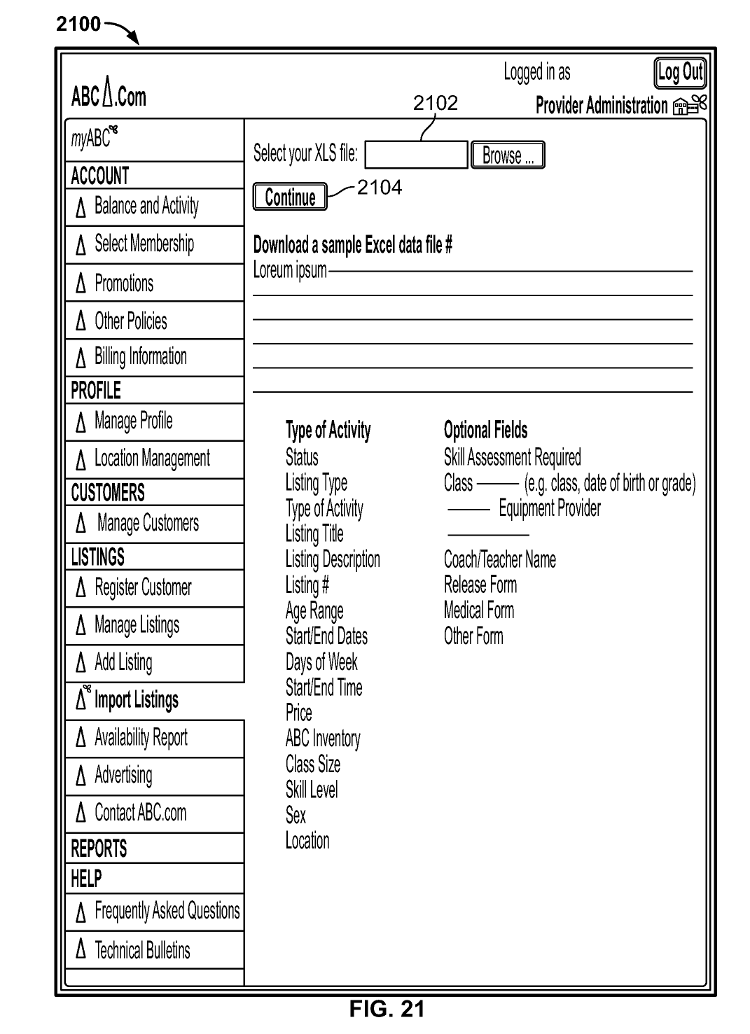

FIGS. 20-21 illustrate various methods by which new activity listings can be created by a provider. FIG. 20 illustrates a user interface 2000 displaying a new activity listing form useable by a provider to create a new activity listing at an activity clearinghouse system, while FIG. 21 illustrates an example user interface 2100 useable by a provider to import an activity record to an activity clearinghouse system.

The user interface 2000 of FIG. 20 includes a number of entry fields useable by a provider to define activity parameters to be included in an activity record, such as the activity record 206 of FIG. 2. The fields include, in the embodiment shown: a listing type, activity type, title, description, coach/teacher, age ranges for youngest and oldest participants, start and end dates of the activity, days of the week the activity occurs, the start and end times of the activity, registration price, tax, class size, online inventory, skill level, gender (if applicable), location, and required equipment. Additional optional fields include a skill assessment field and instructions for skill assessment, prerequisites and prerequisite description, release and release instructions, medical certifications required and instructions for that as well. Other activity parameters and corresponding data entry fields can be included in an activity record (and correspondingly in user interface 2000). An add listing button 2002 allows the provider to create an activity listing using the activity parameters entered into the user interface 2000.

The user interface 2100 of FIG. 21 includes a file browser field 2102, as well as a continue button 2104. The file browser field 2102 allows a provider to select a file from which an activity record can be uploaded to the activity clearinghouse system (e.g., from the provider's local computing system). The continue button 2104 allows a provider to initiate upload of the file selected using the file browser field 2102, thereby creating an activity record in the activity clearinghouse system. Therefore, activity records can be created in an “offline” manner, and transmitted to the activity clearinghouse system using the user interface 2100 rather than having to manually enter each of the activity parameters using the user interface 2000 of FIG. 20.

In the embodiment shown, the user interface 2100 includes a number of instructions regarding format of an example file that can be uploaded to an activity clearinghouse system. Although in the embodiment shown a spreadsheet file is described as having a particular set of data fields, other file types and other fields could be used as well.

Referring now to FIGS. 22-37, example user interfaces are shown that can be viewed and used by users of an activity clearinghouse system to view providers, activities, and profile information, as well as to manage and organize information about scheduled activities for individuals associated with that user. FIG. 22 illustrates an example user interface 2200 listing activity providers registered with an activity clearinghouse system, selectable via a tab feature (labeled “Activity Providers”). The user interface 2200 includes a listing area 2202 listing the various providers and brief descriptions of each provider indicating the types of activities that provider is associated with. The listing area 2202 therefore provides exposure to contents of a provider profile, such as provider profile 202, for viewing by users. The user interface 2200 also includes a plurality of filters, including an activity type filter 2204 and a provider filter 2206. The filters 2204, 2206 allow a user to seek out a specific type of activity or host provider for registration. A search function 2208 allows a user to keyword search for particular providers as well. Results can be printed using a print button 2210, or a link to the particular view can be shared with another user via a share button 2212. Other buttons or features can be included as well.

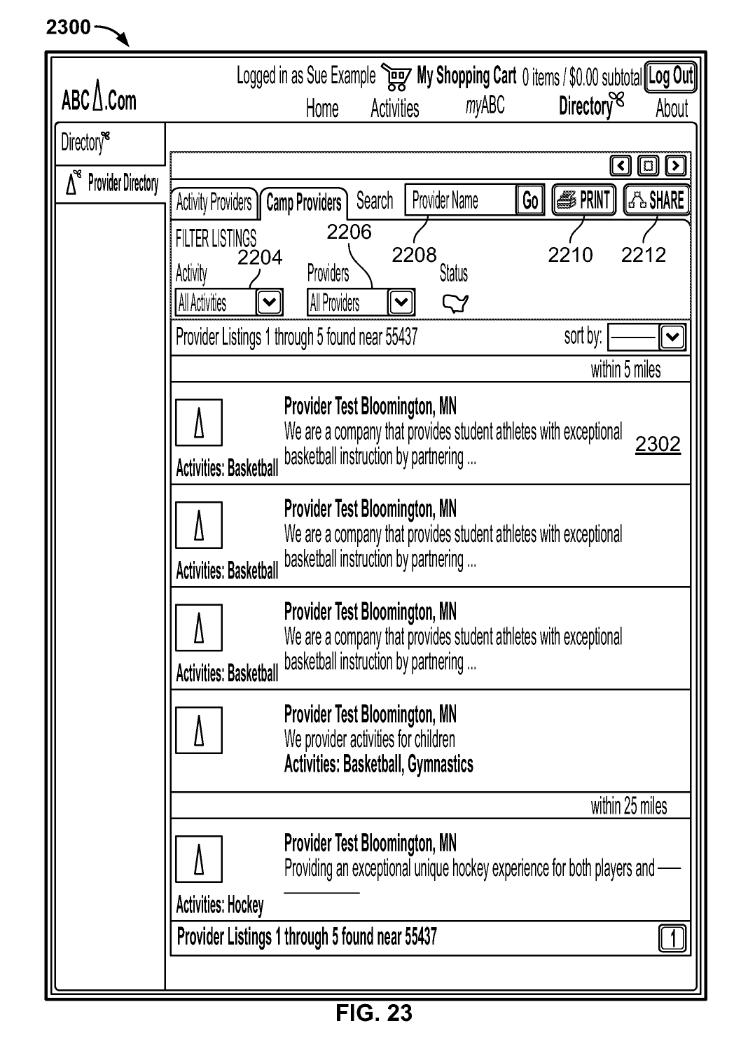

FIG. 23 illustrates a further example user interface 2300 listing additional activity providers and other provider profile information. The user interface 2300 includes a listing 2302 of camps, selectable via a tab arrangement (labeled “Camp Providers”). The user interface 2300 allows analogous search, filter, print, and sharing functionality via buttons 2204-2212 previously described.

Additional user interfaces for differing types of providers could be used, or additional tabs could be presented relating to different types of providers. For example, a community programs user interface could present community programs affiliated with municipalities or other governmental entities. In such situations, the activities may be open to registration, or may be available to attend by the general public (i.e., no registration is required). In such embodiments, the user interfaces could provider analogous functionality to that shown in FIGS. 22-23.

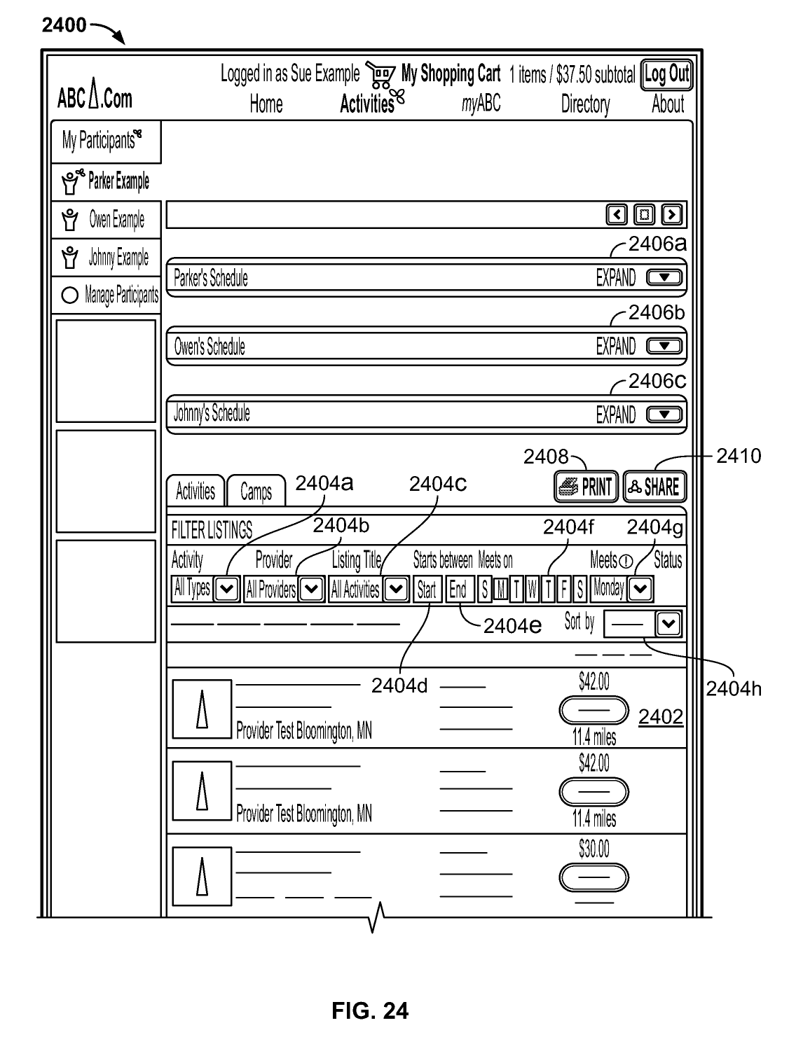

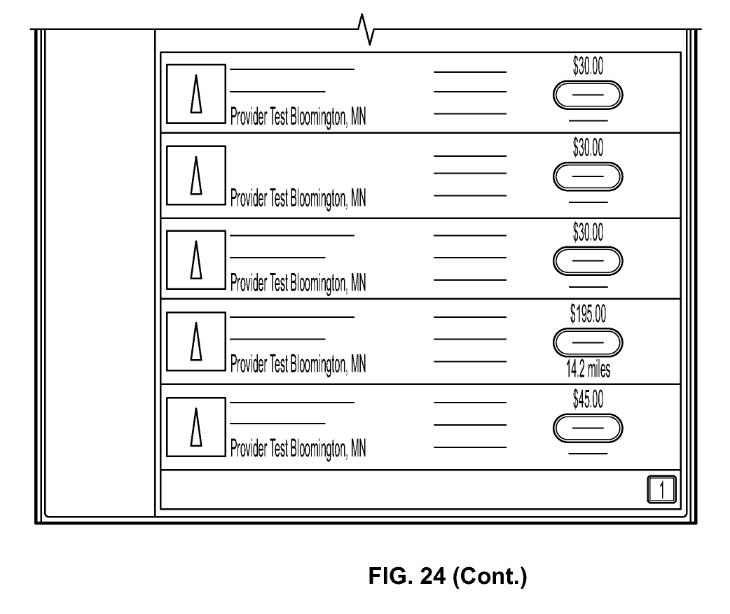

FIG. 24 illustrates a user interface 2400 allowing user search for activities available through the activity clearinghouse system. The user interface 2400 therefore provides a method of exposing activity records to a user of the activity clearinghouse system, such as activity records 206 of FIG. 2. The user interface 2400 includes an activity listing 2402 and a plurality of filters 2404 useable to narrow the list of suitable activities. The activity listing includes a number of activity records including a description of the activity, price of the activity, as well as other information stored in an activity record associated with the activity for viewing and selection by a user. In the embodiment shown, the filters 2404 include an activity filter 2404a, a provider filter 2404b, a listing title filter 2404c, a start date filter 2404d, and end date filter 2404e, a day of the week filter 2404f, and a time of day filter 2404g. Additionally, a distance filter 2404h allows the user to define the distance away of the activity, or filter by distance. Other filters can be used as well.

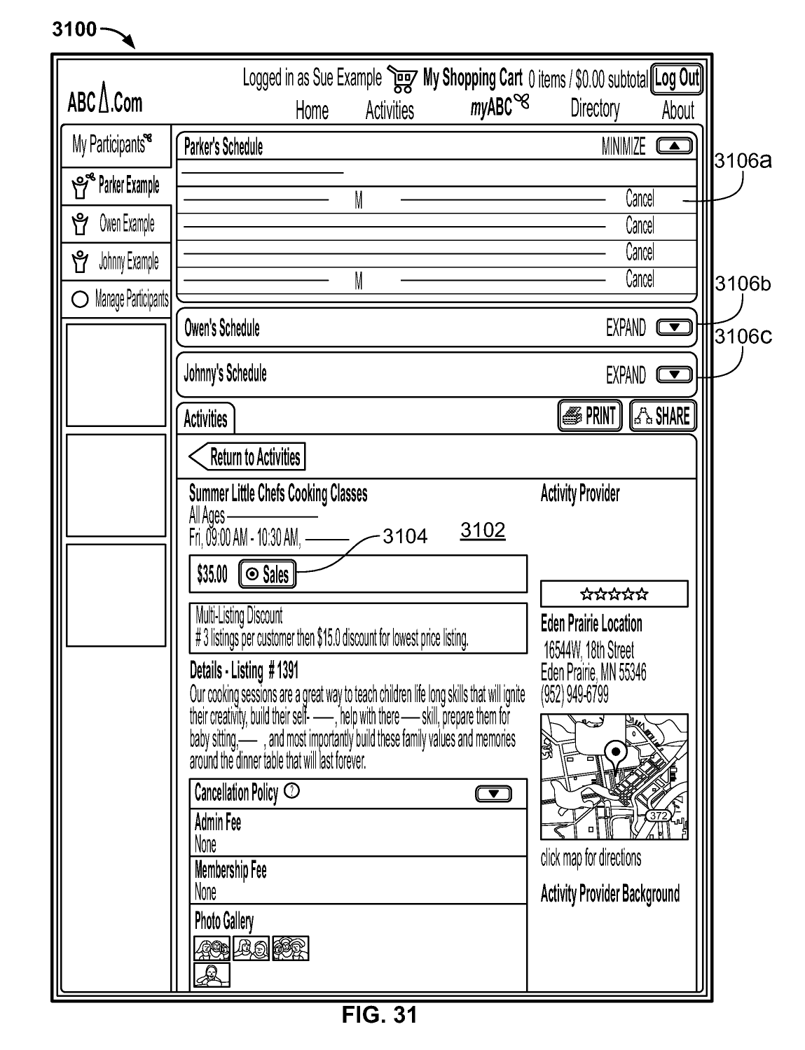

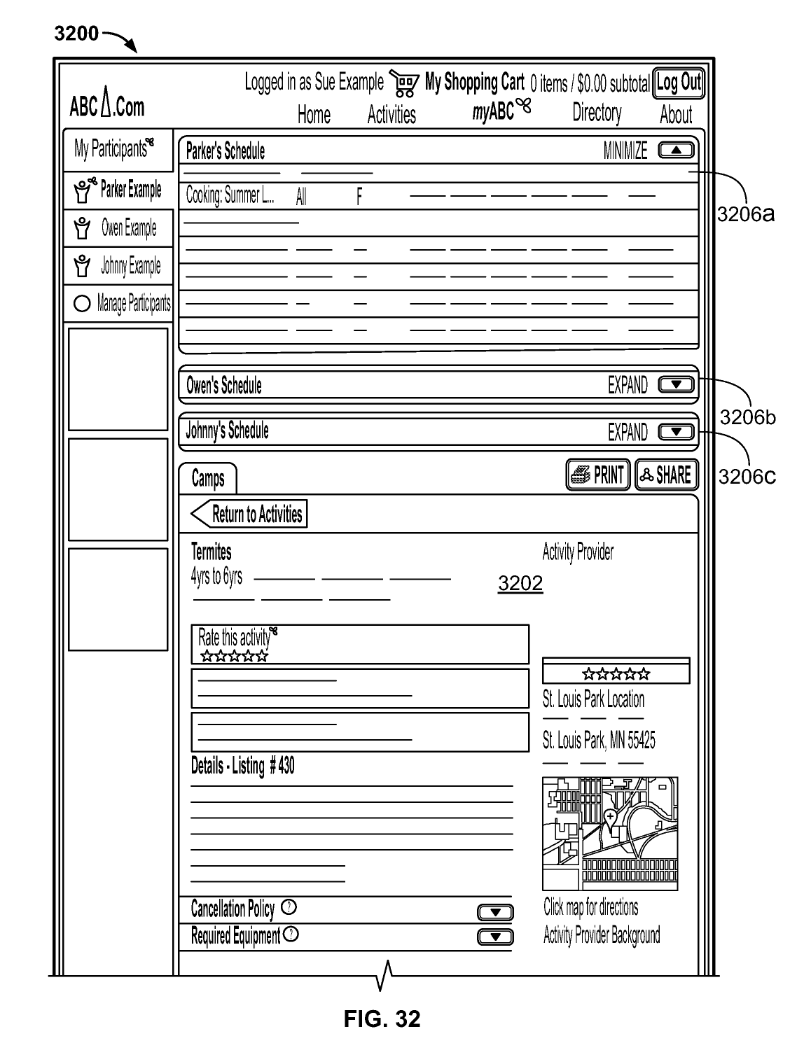

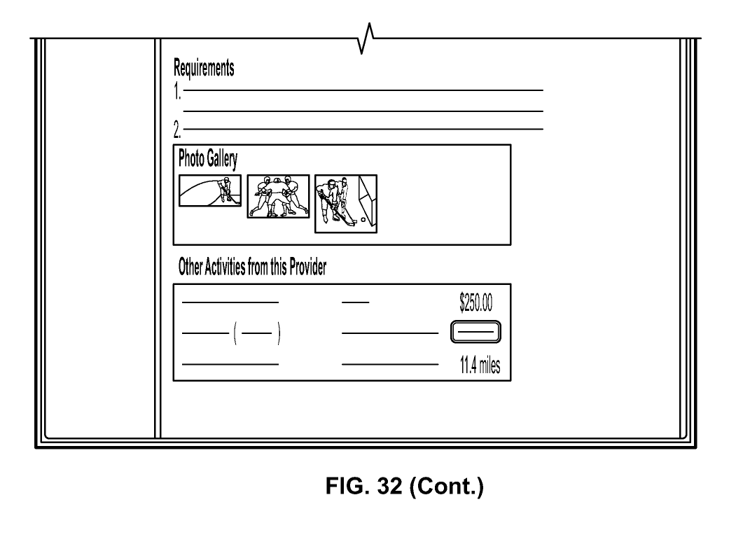

The user interface 2400 also includes a plurality of individual records 2406, which can be expanded to display information regarding activities registered for by the user on behalf of that individual. In the embodiment shown, the user record is associated with three individual records 2406a-c (illustrated as Parker, Owen, and Johnny schedules, respectively). Once an activity is selected and registered for, that activity will be added to the individual record (e.g., as shown in FIGS. 31-32, below). In examples, the individual records 2406a-c can correspond to a group of individuals that are related to one another, such as brothers or sisters in a family. In this manner, each individual's schedule can be accessed by selecting records 2406a-c (e.g., as shown in FIGS. 31-33, below).

As with the other user interfaces described above, the user interface 2400 also includes printing and sharing options 2408, 2410, respectively, the operation of which was previously described in connection with buttons 2210, 2212.

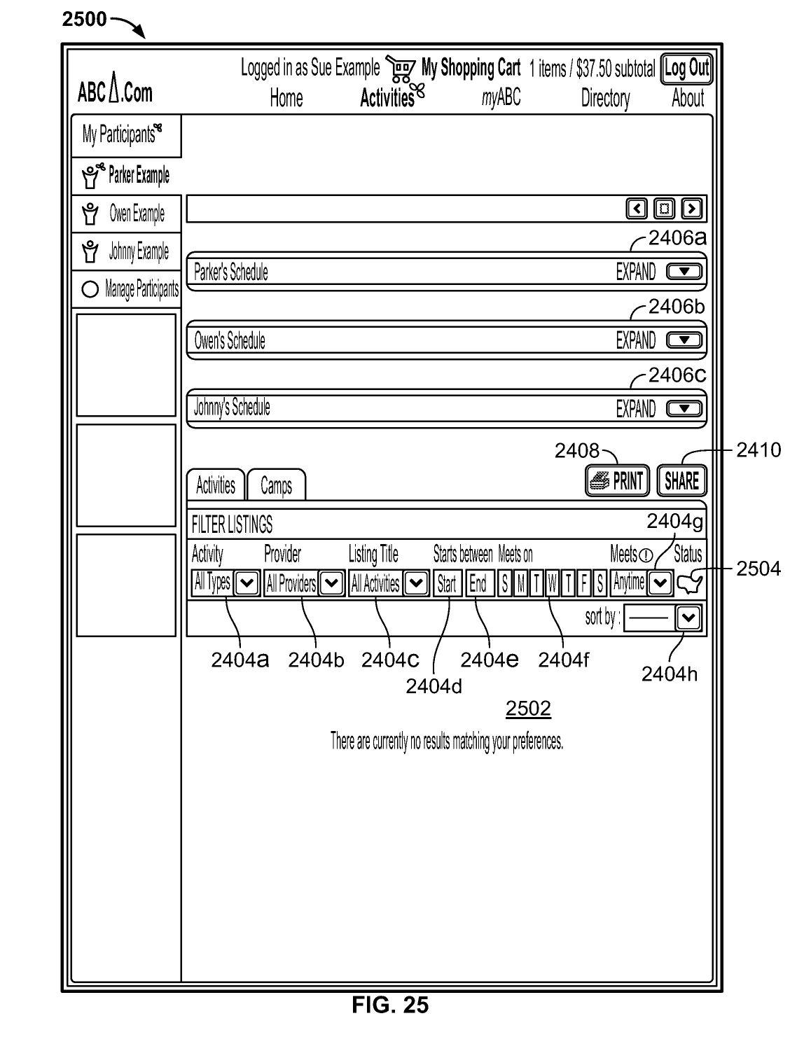

FIG. 25 illustrates a further example user interface 2500 allowing user search for activities, in particular camp activities, available through an activity clearinghouse system. The user interface 2500 includes a camp activity listing 2502, which generally corresponds to the activity listing area 2402 of FIG. 24. The other features of user interface 2500 also generally correspond to user interface 2400 of FIG. 24, and operate in analogous fashion. Additionally, an optional state selector button 2504 allows selection of a state in which the camp resides.

There are other interfaces that can be used to display provider and activity information. For example, the user can select a provider, and a listing of all of the provider's activities can be presented in an activity provider directory interface.

In some embodiments, a detail interface is also presented that provides details about the provider, such as a description of services, contact information, etc. A button is provided on the detail interface that, once selected, displays the various activities associated with the provider that are available for registration.

The detail interface allows providers that do not offer activities for registration to be listed. In such an example, the number of page views for the detail interface can be counted, and the provider can be notified based on the number of views.

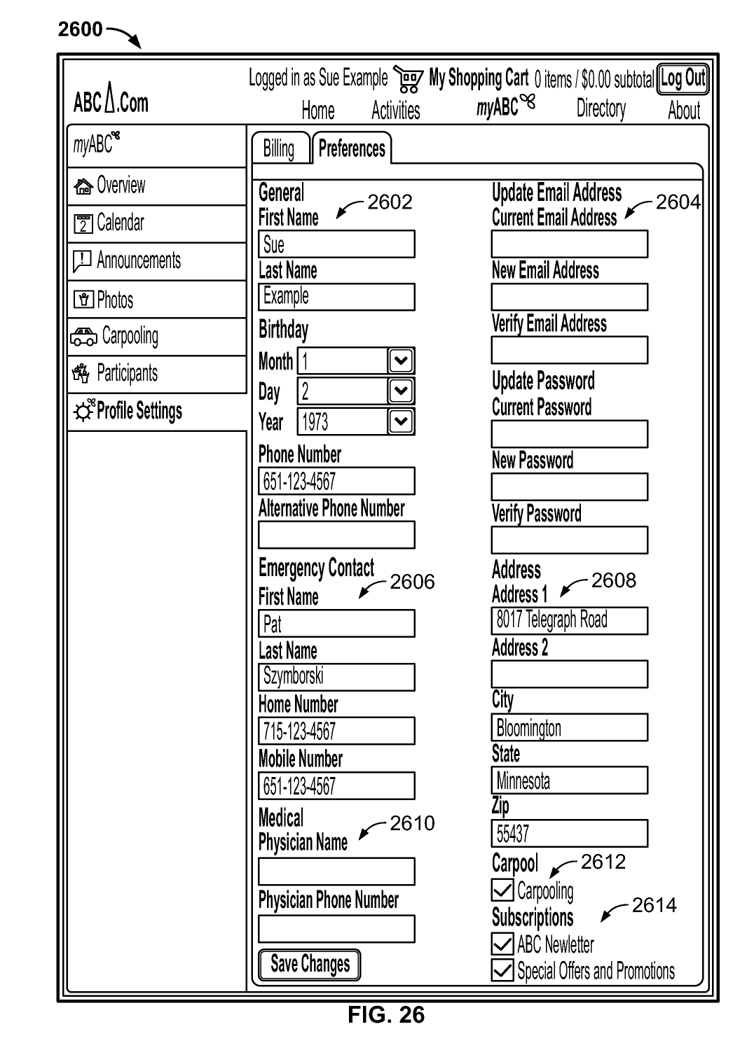

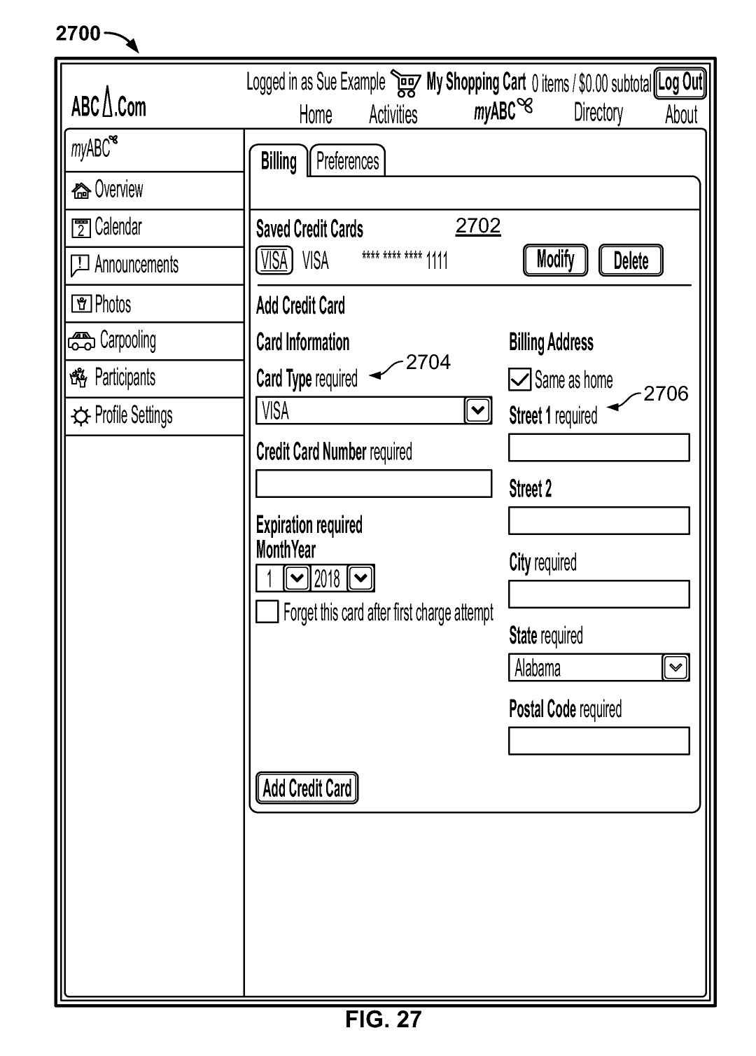

FIGS. 26-27 illustrate user interfaces allowing user editing of profile settings in the activity clearinghouse system, such as settings within that user's user profile 204 of FIG. 2. FIG. 26 illustrates an example user interface 2600 allowing editing of user contact preferences, and FIG. 27 illustrates an example user interface 2700 allowing editing of user billing preferences. The user interface 2600 includes a variety of data entry fields, generally including general information 2602, email contact information 2604, emergency contact information 2606, address information 2608, and medical contact information 2610 (e.g. a doctor or hospital name and contact information). Optional other buttons include carpool 2612 and subscription 2614 options, allowing a user to indicate interest in participating in carpooling or receiving information from the activity clearinghouse at the user's email address relating to upcoming activities. The user interface 2700 includes a saved credit card field 2702, as well as a new credit card entry form 2704 and a billing address form 2706. Other billing information or options could be included in the user interface 2700 as well.

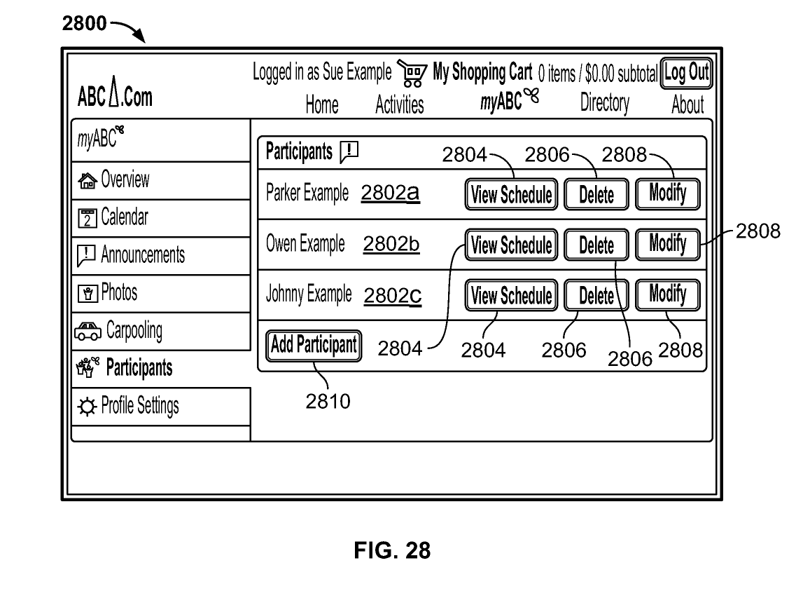

FIG. 28 illustrates an example user interface 2800 displaying individuals associated with a user account. The user interface 2800 includes one or more individual listings 2802 including individuals associated with a user account and for whom the user can sign up for activities. In the embodiment shown, three individual listings 2802a-c are shown; however, more or fewer individual listings can be included in the user interface as well, depending on the contents of a user profile.

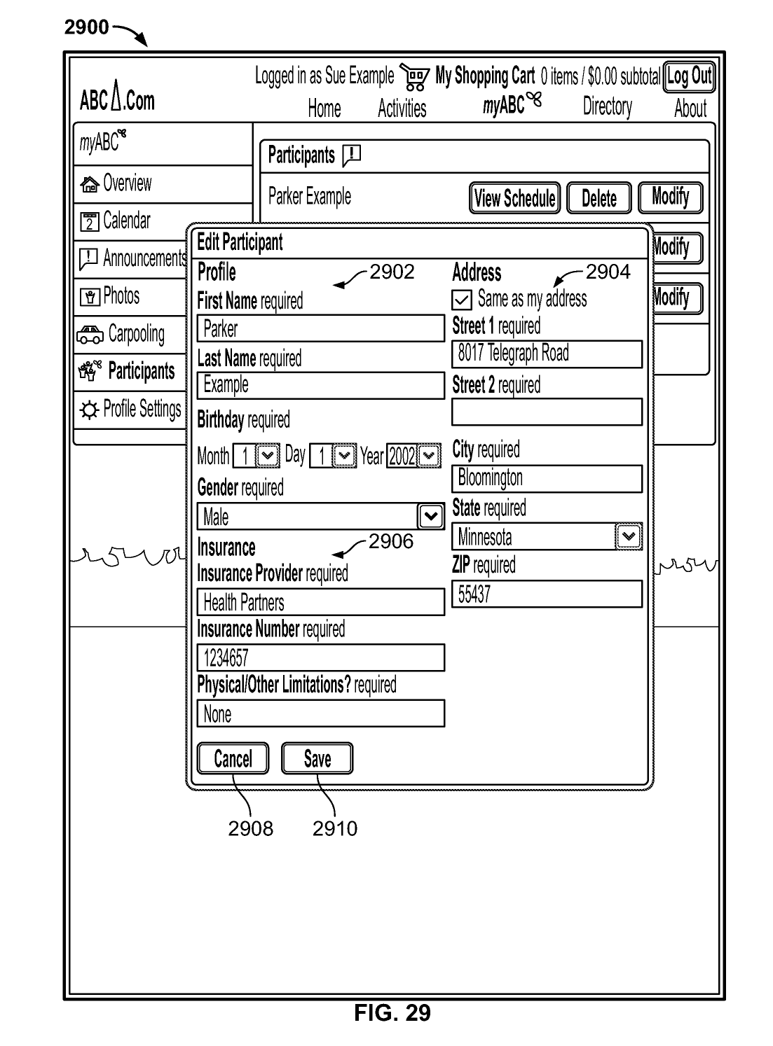

Each individual listing 2802 includes a name as well as a plurality of buttons, including a schedule button 2804, a delete button 2806, and a modify button 2808. The schedule button 2804 causes display of a user interface illustrating the selected individual's schedule (e.g., as shown in FIG. 31, below). The delete button 2806 removes the individual from association with the user's profile and thereby removes data relating to that individual from the activity clearinghouse system. The modify button 2808 allows the user to modify information about the individual, for example by using a form such as the one shown in FIG. 29.

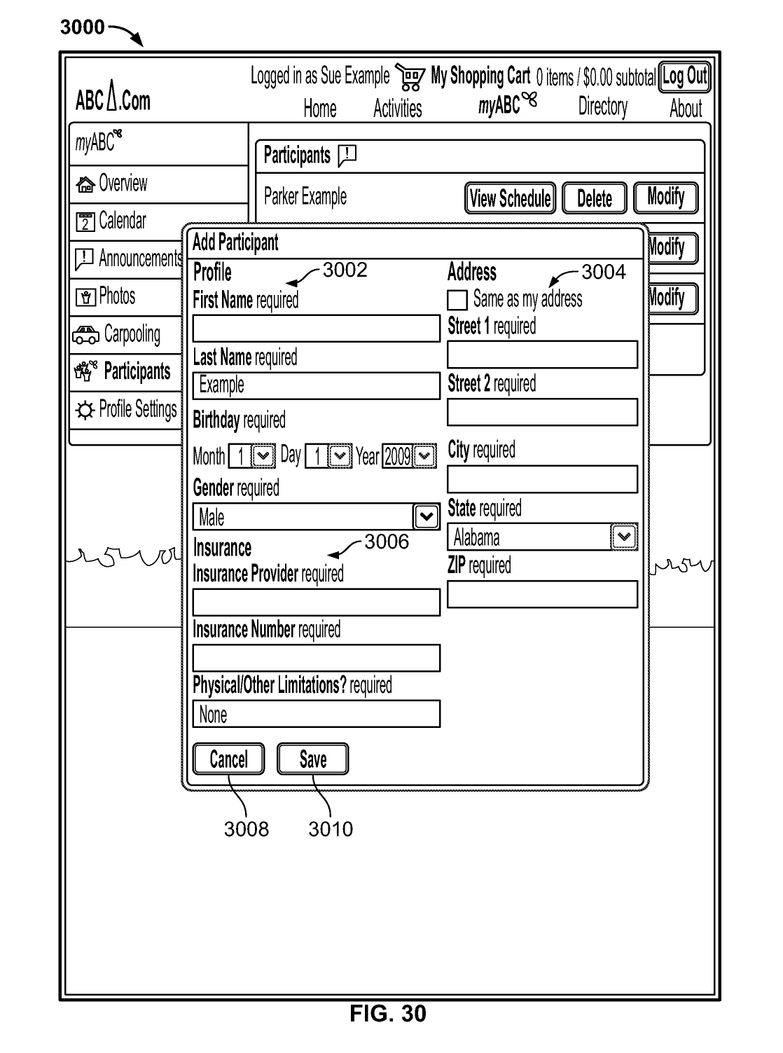

Additionally, the user interface includes an add participant button 2810, which allows the user to add a participant to their profile, thereby allowing the user to sign an additional new individual up for activities using the activity clearinghouse system. An example new individual form is shown in the user interface of FIG. 30.

FIG. 29 illustrates a user interface 2900 for editing a profile of an individual associated with a user account, such as could be presented to a user upon selection of a modify button 2808 associated with one of the users 2802 in FIG. 28. The user interface 2900 includes a number of data entry fields generally organized into profile information 2902, address information 2904, and insurance information 2906. The profile information 2902 includes information typically used to build a roster of individual names for an activity roster, including first and last name, birthday, and gender. The address information 2904 includes street, city, state, and zip code information, and optionally a selectable button (illustrated as selected in the user interface shown) that allows a user to indicate that the individual has the same address as the user (e.g., in the case that the individual is a child or other relative living with the user). The insurance information 2906 includes insurance provider and policy information, as well as a field for the user to report any physical limitations of the individual. Cancel and save buttons 2908, 2910, respectively, allow the user to accept or reject changes to the profile.

FIG. 30 illustrates a user interface 3000 for adding a profile of an individual to a user account. The user interface 3000 includes fields for entering profile information 3002, address information 3004, and insurance information 3006, which generally corresponds to the fields of user interface 2900. Cancel and save buttons 3008, 3010 have analogous effect as well. However, the result of saving the data in the user interface 3000 is that an additional individual record is created and associated with the user profile, and will be displayed in the user interface 2800 of FIG. 28.

Now referring to FIGS. 31-33, example user interfaces are shown that are used to register an individual for an activity. FIG. 31 illustrates a user interface 3100 for user selection of an activity for an individual associated with that user. The user interface 3100 is typically displayed upon user selection of an activity in one of the activity listing user interfaces shown in FIGS. 24-25, in which a particular individual is the selected active individual on whose behalf the user is acting.

The user interface 3100 includes an activity description field 3102, which includes additional details stored in the activity record of the selected activity. The additional details can include, for example, the time, cost, description, fees, and photos of the activity, as well as information about the activity provider. A select button 3104 is included in the activity description field, allowing a user to select and register the currently selected individual for the activity.

In the embodiment shown, three individual records 3106a-c (illustrated as Parker, Owen, and Johnny schedules, respectively) are displayed, with one of these records expanded to show the current contents of that record. As illustrated, the record 3106a lists a number of currently-enrolled activities.

FIG. 32 illustrates an example user interface 3200 upon selection of an activity as illustrated in FIG. 31. The user interface includes an updated listing of activities within the record 3106a, in which the selected activity (illustrated as “Cooking”) is now included. An updated activity description field 3202 now displays a different activity, such as another activity that may interest that individual based on the activity that was added to that individual's schedule.

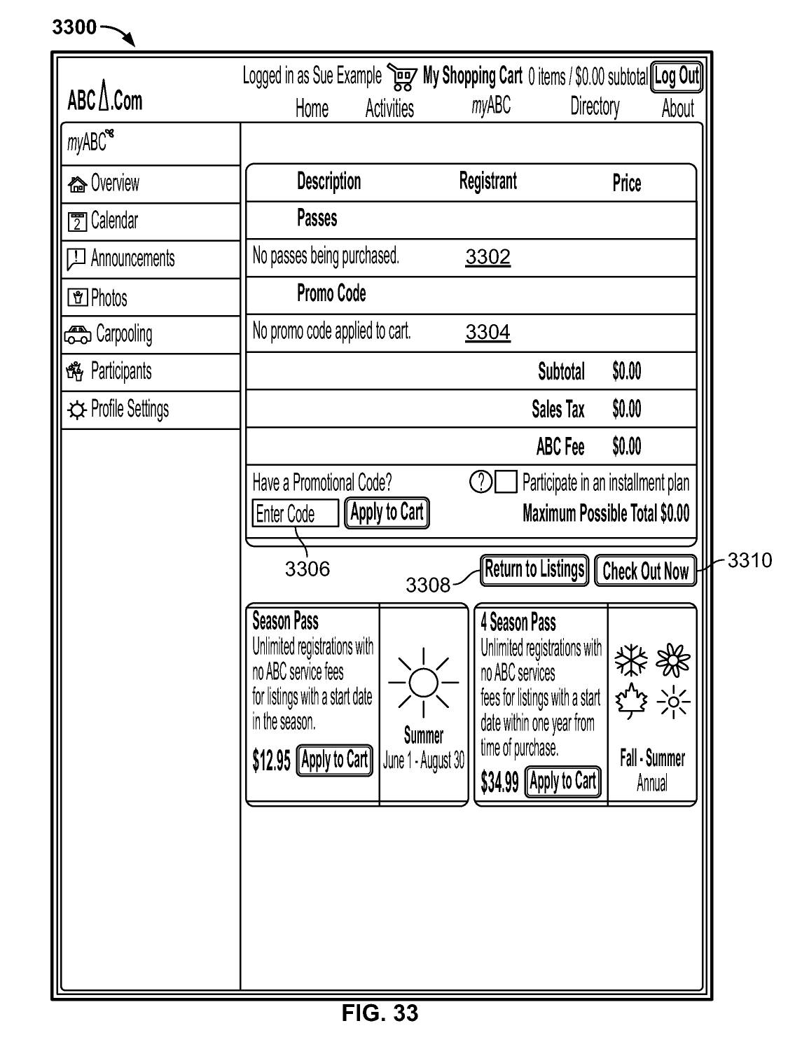

FIG. 33 illustrates a shopping cart user interface 3300. The shopping cart user interface 3300 displaying a shopping cart of user activities selected via the select button 3104 of FIG. 31, and includes a generally conventional payment processing arrangement. The user interface 3300 includes an activity listing field 3302 for listing activities to purchase, as well as a promotional code listing 3304 and promotional code entry field 3306 for entering promotional codes received from providers (e.g., to reduce the price of the selected activities). The shopping cart user interface includes a return button 3308 that allows the user to continue browsing activities, and a “check out now” button 3310 allowing the user to proceed to payment (e.g., by entering credit card or other payment information into a conventional form, not shown).

Referring now to FIGS. 31-33 generally, it is understood that selecting, registering, and paying for an activity can occur in any of a number of orders. For example, in the embodiment shown, a user can select and register for an activity, and later use the shopping cart user interface 3300 to pay for registered activities. In alternative embodiments, the user may be required to pay for the activity before it is displayed in an individual's schedule; therefore, selection of an activity in user interface 3100 would lead the user first to the shopping cart user interface 3300, and following payment to the user interface 3200 displaying the activity in the individual's schedule. Alternative arrangements and/or user interface sequencing for activity registration is possible as well.

In certain embodiments, additional fees can be charged by the user as well. Using payment settings saved into user interface 2700 and designated in a shopping cart interface (e.g., user interface 3300), a user could pay any of a number of different types of activity fees, equipment fees, or other fees to a provider, either on a predefined basis or by designating an amount of payment to the activity clearinghouse system. These fees may be predefined, or could be set by the user or provider at the time of purchase and user authorization of a particular charge. In this manner, the activity clearinghouse system operates as the provider's merchant account and crediting back to the provider payments made, thereby making the provider have a separate account unnecessary.

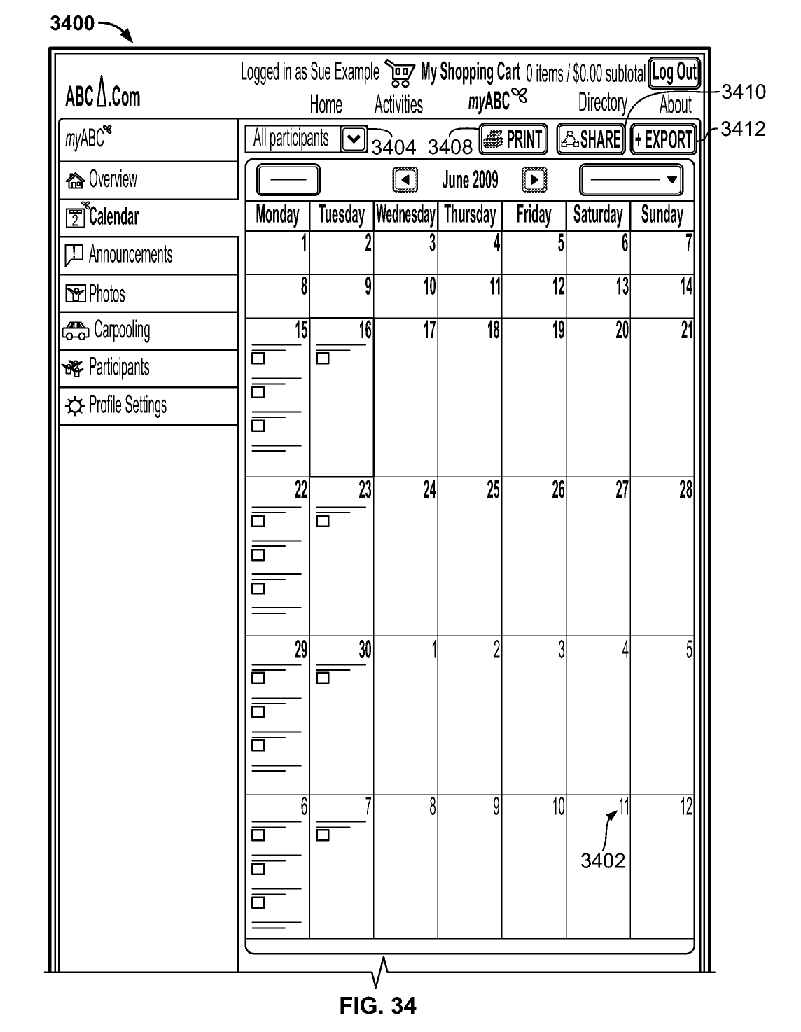

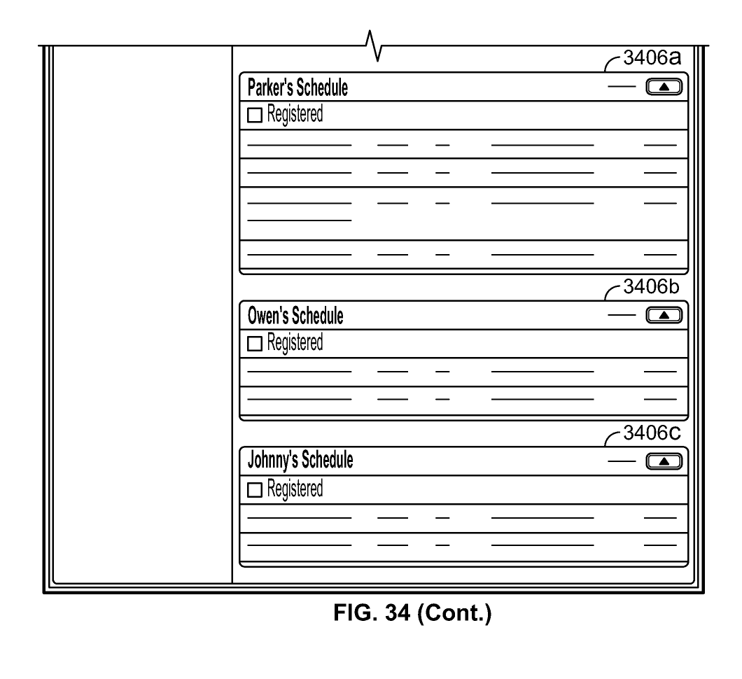

FIG. 34 illustrates a user interface 3400 displaying a calendar of activities for a plurality of individuals associated with a user. The user interface 3400 includes a calendar field 3402, which displays a monthly calendar view of activities for each individual associated with the user. In alternative configurations, the calendar field 3402 can display a daily, weekly, or other type of calendar view (e.g., using the “today” or “go to date” buttons at the top of the calendar field). The user interface 3400 also includes an individual filter 3404 that can be used to select a particular individual associated with the user. Upon selection of an individual using the filter 3404, the calendar field 3402 updates to display only activities that individual is registered for.

Individual schedule record listings 3406 are also included in the user interface 3400. In the embodiment shown, three individual schedule record listings 3406a-c are shown, corresponding to three individuals associated with a user viewing the user interface 3400. The individual schedule record listings 3406 provide a listing of each of the activities within the selected timeframe of the calendar view for which that individual is scheduled.

Additional features can be included in the user interface as well. In the embodiment shown, a print button 3408 allows the user to print a copy of the current view of the schedule. A share button 3410 allows the user to share a link to the schedule with another user of the activity clearinghouse system or to provide temporary access to an individual having an email account but who is not otherwise a user of the activity clearinghouse system. An export button 3412 allows the user to export a file (e.g. a flat file, spreadsheet, or calendar item file) for local storage on a user's computing system or incorporation into that user's local productivity/messaging software suite (e.g. Microsoft Outlook, Gmail/Google Calendar, Lotus Notes, or other productivity software).

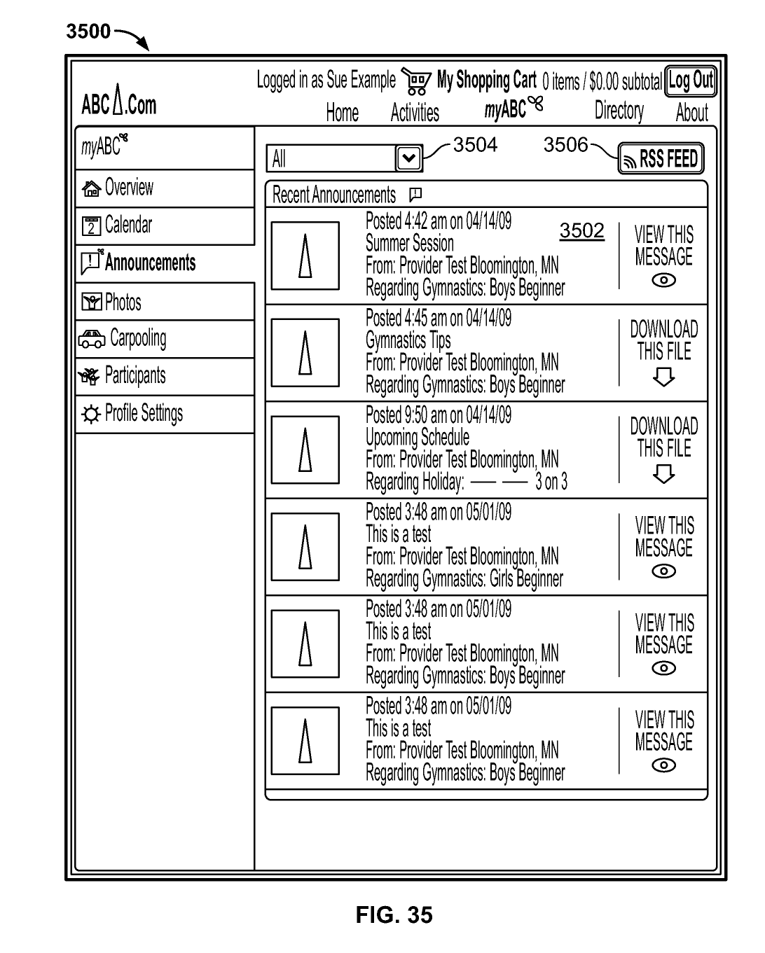

Now referring to FIGS. 35-37, user interfaces are shown that are useable for managing and executing event-based tasks, such as tasks that are activity specific and may be managed via an activity administration module 216. FIG. 35 illustrates a user interface 3500 displaying announcements by providers for activities in which a user has registered one or more individuals. The user interface 3500 includes an announcement listing field 3502 which includes a plurality of announcement records associated with activities that user has signed an individual up for. Each announcement can be associated with an activity record, and can be accessed due to the link between the individuals in the user record and registered activities. The announcements can be information about the particular activity, documents to download concerning the activity, or other information that the activity provider wishes to communicate regarding a selected activity. The user interface also optionally includes a filter menu 3504 allowing a user to view only a subset of the announcements (e.g., announcements concerning only a particular date range, individual, or sport), as well as a RSS feed button 3506 allowing activation of an RSS feed to the user of all or some of the announcements.

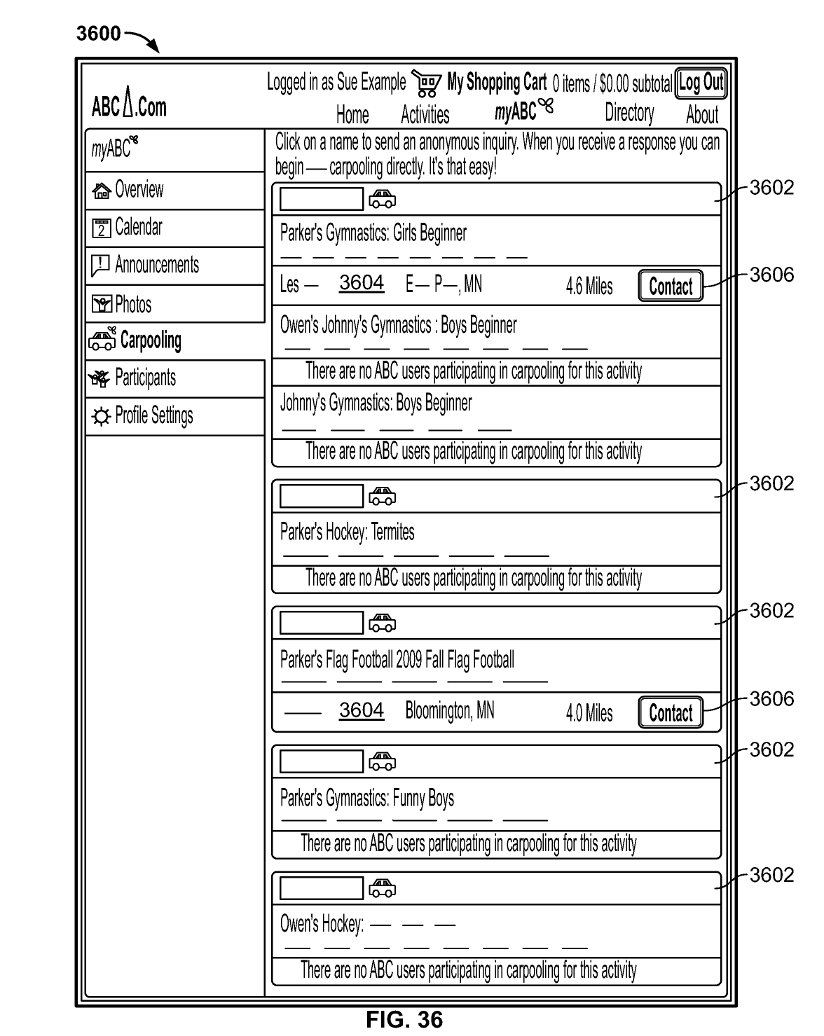

FIG. 36 illustrates a user interface 3600 facilitating possible carpooling to activities. The user interface 3600 therefore allows users (e.g. parents) to coordinate rides for individuals (e.g. children) to activities and share driving responsibilities. The user interface 3600 includes a plurality of location fields 3602, each of which correspond to a location at which an activity takes place and for which the user has registered an individual. The location fields 3602 can include a number of different entries corresponding to different activities occurring at that location, and can include a number of pieces of information, including the activity and times for which travel to the particular location would be required. For example, the first-listed field 3602 has three different classes scheduled for three different individuals and at three different times, while the second listed field 3602 has only a single class scheduled. For each registered activity/location, each location field 3602 will include a listing 3604 of any other users of the activity clearinghouse system who (1) also are associated with an individual attending that particular activity, and (2) have indicated in their user record that they would be interested in carpooling arrangements (e.g., by selecting carpool button 2612 of FIG. 26). Each listing 3604 can include any of a number of pieces of information relevant to carpooling, such as the name and location of the interested carpooler, so that the user can determine whether to contact the user represented by the listing 3604. A contact button 3606 can also be included in the listing, and can be used to send a message to the interested carpooler and initiate a carpool arrangement.

In certain embodiments, the listings 3604 related to carpool arrangements only include a predetermined number of geographically close potential carpooling partners; however, in other embodiments, all users interested in carpooling to a particular location are displayed in association with that location field.

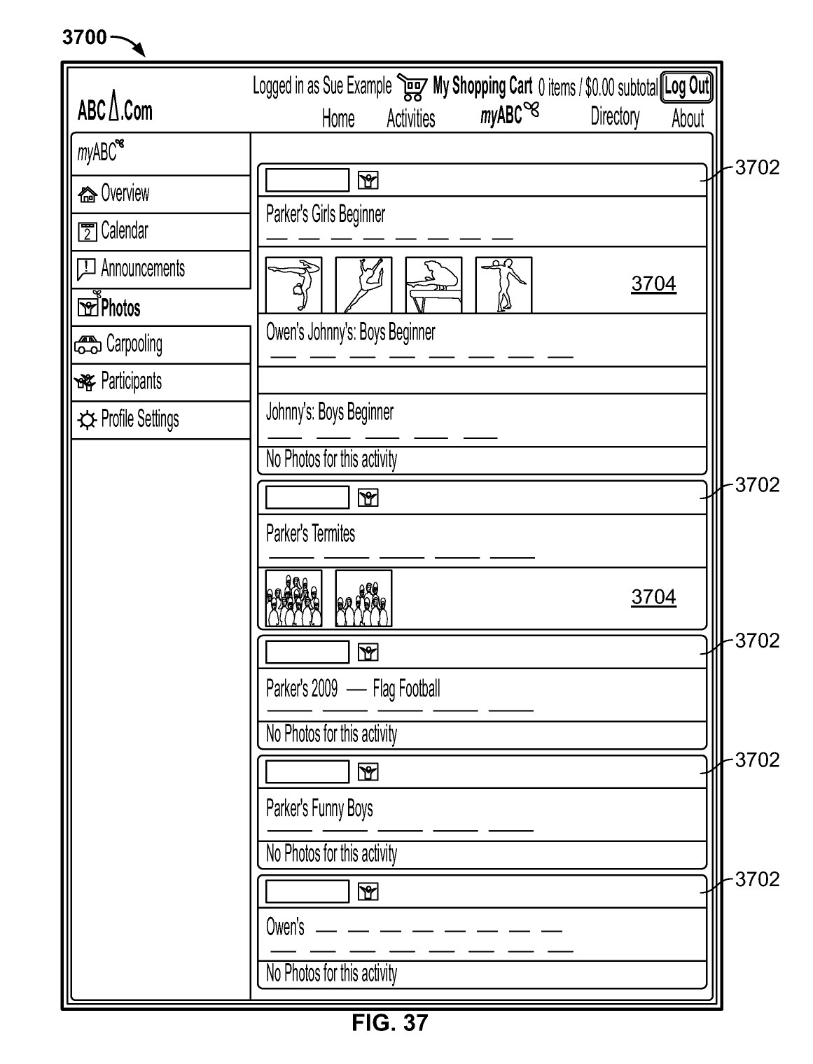

FIG. 37 illustrates a user interface 3700 that allows display and sharing of photographs associated with activities. Similar to the carpooling user interface of FIG. 36, the user interface 3700 also includes a plurality of location fields 3702 separated by activity, and including details regarding that activity. However, in the user interface 3700, within each activity can be a photo listing 3704, which either lists or (in the embodiment shown) displays thumbnail versions of photographs taken in association with that activity, or representative of that activity. In various embodiments, the user interface 3700 can be used to upload, view, or edit photographs accordingly.

Referring generally to FIGS. 7-37, it is understood that the user interfaces described are intended only as example interfaces useable to implement aspects of the present disclosure. Additional user interfaces can be included as well, such as enrollment reporting interfaces, cost reporting interfaces, or other interfaces facilitating user interactivity or provider management of activities. Furthermore, the layout and functionality of the user interfaces could differ from that illustrated in the particular examples described above.

In certain example embodiments, additional fields could be presented to providers in the user interfaces of FIGS. 7-22 reflecting pending issues related to registration or class creation. For example, a pending issue may relate to low inventory for a class, class prerequisites or skill assessments, disputed discounts to be applied, or other matters requiring intervention by the provider. The pending issue may be presented to the provider within that provider's profile, allowing the provider to resolve any pending issues as required. Optionally, the pending issues could be set to expire if a provider does not take action with respect to the issue within a preset amount of time (e.g., 5 days); however, in other arrangements, pending issues remain pending until addressed by the provider.

Furthermore, a number of additional user interfaces or features of user interfaces could be incorporated for access by a provider in the context of the activity clearinghouse system. For example, a branding interface could be presented to the provider, allowing the provider to establish additional logos (beyond the logo upload functionality of FIG. 14). Furthermore, the user interfaces described herein (including both interfaces of FIGS. 7-21 and 22-37) can be conformed to an appearance similar to that of the provider's own website, or hosted within a frame within the provider's website, thereby avoiding navigation away from the provider's website.

Additionally, in conjunction with generation of the user interfaces of FIGS. 7-37, it is understood that an activity clearinghouse server may transmit messages to the various entities using that clearinghouse upon occurrence of various types of events. For example, a provider may be sent an email or other report upon the activity server receiving a registration for an activity by a user, or upon detection of a pending issue. In other arrangements, the provider can be sent emails regarding other events, such as confirmation emails regarding changes made to the provider profile by that provider. Concurrently, users can opt to receive emails as well, such as upon occurrence of events caused by either users (confirming the user action, e.g., ordering enrollment in an activity) or by providers (e.g., creation of a new activity for review by the user), or by the activity clearinghouse system (e.g., the resolution of a second-choice enrollment option or first-choice enrollment option with respect to given activities).

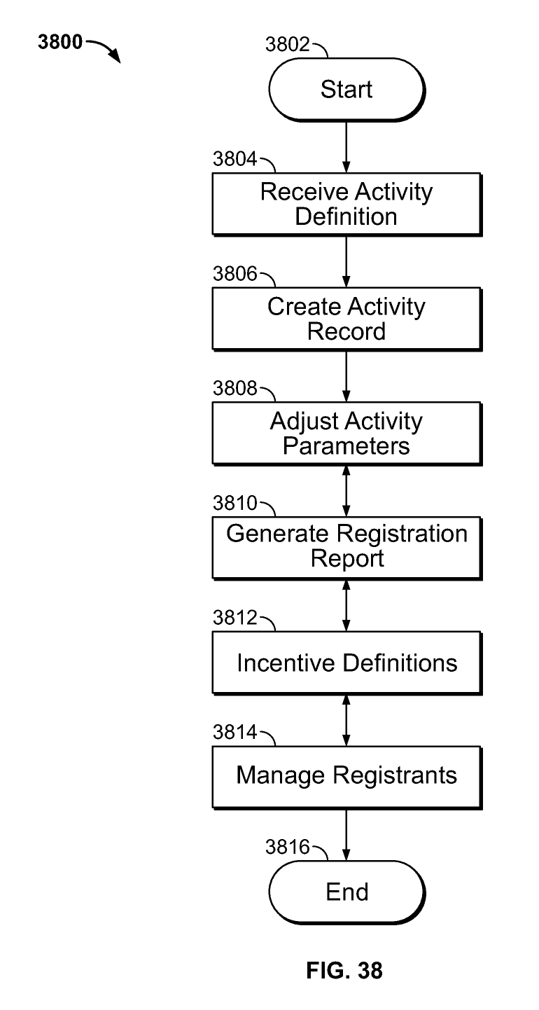

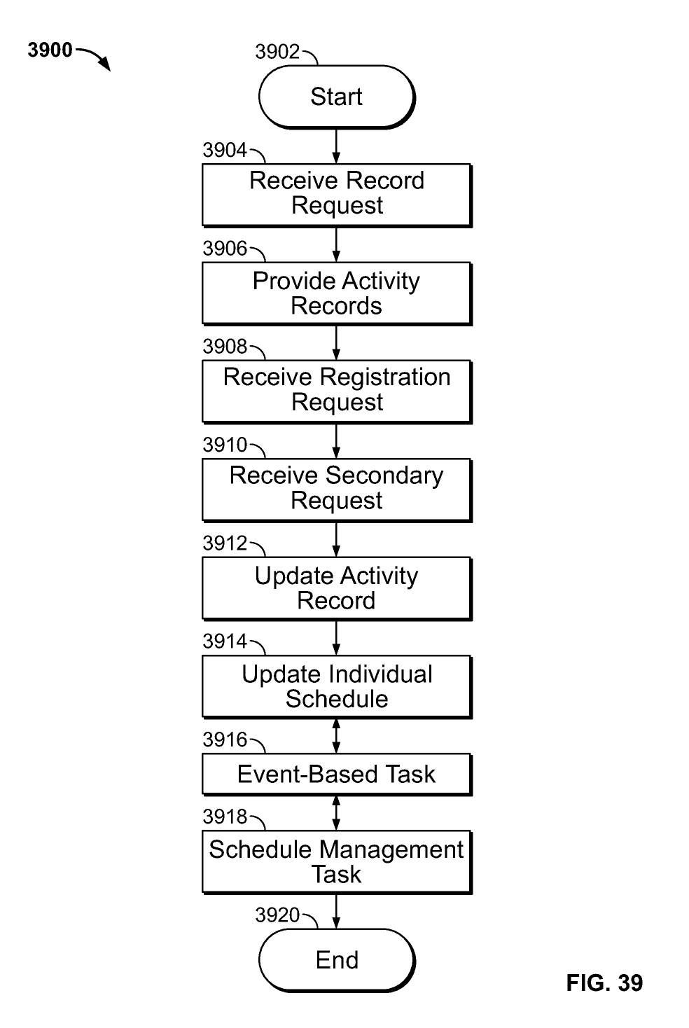

Now referring to FIGS. 38-39, methods and systems for usage of an activity clearinghouse system are described. The activity clearinghouse system can in certain embodiments correspond to the system 102 of FIGS. 1-6, and can optionally be implemented using some or all of the user interfaces of FIGS. 7-37.

FIG. 38 is a flowchart of methods and systems 3800 for facilitating creation and management of activities using an activity clearinghouse system. The methods and systems 3800 are useable by a provider to establish and/or manage activities associated with that provider, and can be used in association with a number of providers to compile a diverse set of activities at the activity clearinghouse system. The methods and systems are instantiated at a start operation 3802, which corresponds to detecting initial access by a provider in the activity clearinghouse system.

Operational flow proceeds to an activity definition receipt module 3804, which corresponds to receipt of an activity definition including activity parameters from an activity provider. An activity record creation module 3806 creates the corresponding activity record, populating predetermined fields with the information defined by the provider. At this point during interaction with a provider, the activity is published for access, review, and registration by a user (as could occur using the methods and systems 3900, below).

A parameter adjustment module 3808 allows a provider to adjust any of the activity parameters associated with a selected activity record. For example, the provider could adjust the cost or registration fee for an activity after the activity has been established, or could adjust the definition or skill level of the activity, or change other parameters described herein, such as by using the user interfaces 1900, 2000 of FIGS. 19-20.

An optional report generation module 3810 can be executed at any time, and generally provides to an activity provider an indication of the current status of an activity, including current enrollment, activity rosters, money collected, or other information. The provider can view the report to determine the status of registration or other factors related to that provider's activities. An optional incentive definition module 3812 allows the provider to set special activity registration pricing or provide some other incentive for a user to register individuals for an activity that is not filled or that there is not sufficient interest in, or for all activities associated with that provider, such as could be accomplished using the user interface 900 of FIG. 9. A registrant management module 3814 allows the provider to edit a roster of names related to an activity or otherwise manage registrants in an activity associated with that provider.

An end operation 3816 corresponds to completed editing of an activity record or modification of various features related to an activity by a provider, such that the provider ceases to access that activity record.

FIG. 39 is a flowchart of methods and systems 3900 for facilitating browsing and registration in activities and management of activity schedules using an activity clearinghouse system. The methods and systems 3900 generally allow a user to access and manage information at the activity clearinghouse system, as opposed to the methods and systems 3800 which relate to provider access features. The methods and systems 3900 are instantiated at a start operation 3900, which corresponds to initial access of the activity clearinghouse system by a user.

Operational flow proceeds to a record request module 3904, which corresponds to receipt of a request for one or more activity records by a user at the activity clearinghouse system. The record request module 3904 can define any of a number of records according to any filters or other selection criteria, as illustrated in the user interfaces 2400-2500 of FIGS. 24-25. A provide record module 3906 returns the listing of activity records to a user, for example generating the activity listings 902, 1002 illustrated in those user interfaces 2400, 2500.

A registration request module 3908 corresponds to receipt of a registration request from a user to register one or more individuals in a selected activity. Additionally, an optional secondary request module 3910 allows a user to define a “second choice” activity to register for, in the event the activity selected in conjunction with the registration request module 3908 is full or otherwise unavailable.

An update activity record module 3912 operates to link a user and individual with an activity upon user registration of that individual for the activity. The update activity record module 3912 updates the record of enrollment in that record, as well as remaining capacity and other enrollment-based factors related to the activity. A schedule update module 3914 updates the schedule associated with that user (and optionally the schedule of a particular individual associated with the user). An example of an updated schedule is shown in the example sequence of adding an activity shown in the user interfaces of FIGS. 31-32, above, and as reflected in the calendar user interface of FIG. 34.

An event-based task module 3916 optionally performs at least one event-related task in association with an event, or allows a user to perform such a task. Example tasks can include uploading or reviewing photographs; viewing or searching for announcements relating to an activity; and locating, setting up, or making oneself available for a carpool. The event-based task module 3916 can therefore correspond, for example, to user action taken (and resulting processing by the activity clearinghouse system) using any of the user interfaces of FIGS. 35-37, above. It is noted that the event-based task module 3916 can be executed either before, during, or after occurrence of the activity, the selection of which largely depends upon the particular task to be performed. For example, setting up a carpool may occur before occurrence of an activity, but uploading of activity photographs would generally occur after the activity. Other event-based tasks could be performed by the event-based task module 3916 as well.

A schedule management task module 3918 optionally performs at least one schedule-related task, and allows a user to execute and view the results of such tasks. Example schedule-related tasks can include generating a calendar with respect to one or more individuals associated with the user, editing that calendar, or sharing an activity calendar with another registered user of the activity clearinghouse system, as described in the example of FIG. 34, above. Other schedule-based tasks could be performed by the schedule management task module 3918 as well.

Operational flow terminates at an end operation 3920, which corresponds to a completed user session accessing information in the activity clearinghouse system.

Referring now to FIGS. 38-39, it is understood that a number of the operational modules can be executed in any order, and that no particular order is imputed to these methods and systems by the order of description of the modules. Furthermore, additional functionality can be included in either of the methods and systems 3800, 3900.

Furthermore, and relating to the overall system of FIGS. 1-39, by use of the various computing systems, user interfaces, and methods of the present disclosure, a central arrangement for managing activities is provided which allows activity providers to create and edit in realtime activity listings associated with activities that they host, while providing users a central location for management of activities by a number of different, unaffiliated providers. The present disclosure also therefore provides for management and coordination of multiple individual schedules by a single user.

The above specification, examples and data provide a complete description. Many alternative embodiments can be made without departing from the spirit and scope of the disclosure.

What is claimed is:

1. An activity clearinghouse system comprising:
a memory configured to store an activity database containing a plurality of activity records;
a programmable circuit operatively connected to the memory, the programmable circuit configured to execute programmable instructions that, when executed, cause the activity clearinghouse system to:
receive requests from a plurality of activity providers to create activity records in the activity database, each activity record including a plurality of activity parameters;
receive a request from a user to view one or more of the activity records, the request including at least one activity parameter selected by the user;
in response to the request, provide to the user the one or more activity records including the at least one activity parameter selected by the user;
receive a request from the user to register an individual for a selected activity associated with an activity record; and
update the activity record to reflect registration of the individual for the selected activity.

2. The activity clearinghouse system of claim 1, wherein the programmable circuit is further configured to execute programmable instructions to generate a report associated with an activity provider, the report including registration information related to activity records created by that provider.

3. The activity clearinghouse system of claim 1, wherein the plurality of activity parameters are selected from the group consisting of:
age range;
skill level;
activity type;
activity rules and requirements;
activity cost;
activity promotional cost;
registration time period;
sport;
date;
time;
duration;
gender; and
residency.

4. The activity clearinghouse system of claim 1, wherein one or more of the requests from the activity providers include a general description of the goods or services offered by each of the activity providers.

5. The activity clearinghouse system of claim 1, wherein the programmable circuit is further configured to provide a report to each of the activity providers regarding subsequent access and registration actions taken within the activity clearinghouse system with respect to created activity records.

6. The activity clearinghouse system of claim 1, wherein the programmable circuit is further configured to search the activity records based on one or more query terms provided by the user.

7. The activity clearinghouse system of claim 6, wherein the query terms from the user are compared to the activity parameters associated with each of the activity records.

8. A method of managing activity registrations on an activity clearinghouse system, the method comprising:
receiving at the activity clearinghouse system requests from a plurality of activity providers to create activity records in the activity database, each activity record including a plurality of activity parameters;
receiving at the activity clearinghouse system a request from a user to view one or more of the activity records, the request including at least one activity parameter selected by the user;
in response to the request, providing to the user the one or more activity records including the at least one activity parameter selected by the user;
receiving at the activity clearinghouse system a request from the user to register an individual for a selected activity associated with an activity record; and
updating the activity record to reflect registration of the individual for the selected activity.

9. The method of claim 8, wherein the individual is associated with a user account associated with the user.

10. The method of claim 8, wherein the individual is a child of the user.

11. The method of claim 8, further comprising receiving from the user a request to create a profile for the individual.

12. The method of claim 11, further comprising, upon receiving the request from the user to register the individual, associating the activity record with the profile associated with the individual.

13. The method of claim 12, wherein the profile includes a schedule of activities associated with the individual.

14. The method of claim 13, further comprising generating a calendar depicting the schedule of activities associated with the individual.

15. The method of claim 14, wherein the calendar includes activities associated with each individual associated with a user.

16. The method of claim 8, further comprising:
upon updating the activity record to reflect registration of the individual for the selected activity, billing the user an amount at least equal to the registration fee associated with the activity; and
crediting the registration fee to an account associated with the provider.

17. A method of managing activity registrations on an activity clearinghouse system, the method comprising:
receiving at the activity clearinghouse system requests from a plurality of activity providers to create activity records in the activity database, each activity record including a plurality of activity parameters;
receiving at the activity clearinghouse system a request from a user to view one or more of the activity records, the request including at least one activity parameter selected by the user;
in response to the request, providing to the user the one or more activity records including the at least one activity parameter selected by the user;
receiving at the activity clearinghouse system a request from the user to register an individual for a selected activity associated with an activity record;
updating the activity record to reflect registration of the individual for the selected activity;
receiving from the user a request to create a profile for the individual, wherein the profile includes a schedule of activities associated with the individual;
upon receiving the request from the user to register the individual, associating the activity record with the profile associated with the individual; and
generating a calendar depicting the schedule of activities associated with the individual.

18. The method of claim 17, wherein the individual is associated with a user account associated with the user.

19. The method of claim 17, wherein the individual is a child of the user.

20. The method of claim 17, further comprising:
upon updating the activity record to reflect registration of the individual for the selected activity, billing the user an amount at least equal to the registration fee associated with the activity; and
crediting the registration fee to an account associated with the provider.
